(19) United States
(12) Patent Application Publication
(10) Pub. No.: US 2010/0070291 A1
(43) Pub. Date: Mar. 18, 2010

(54) Business_on_a_page

(75) Inventor: Aslam Taher Handy, Richmond, VA (US)

Correspondence Address: Aslam Handy, 2312 W Grace Street, Richmond, VA, 23220, US

(73) Assignee: Aslam Handy, Richmond, VA (US)

(21) Appl. No.: 12/584,558

(22) Filed: Sep. 8, 2009

Related U.S. Application Data
(60) Provisional application No. 61/095,693, filed on Sep. 10, 2008.

(51) Int. Cl. G06Q 99/00

(52) U.S. Cl. 705/1.1

(57) ABSTRACT

Enterprise architecture is an emerging discipline that cuts across arts, science and religion. Enterprise architecture is increasingly seen as the best way to optimize existing IT investment while planning for future growth in areas like green IT, healthcare IT and medical tourism. Only by establishing a blueprint with which to operate can companies comply with corporate and government mandates requiring closer alignment of business processes with IT investment. Further, since change is a constant in IT, the blueprint must be dynamic enough to anticipate and adapt to evolving business models and economic trends. The blueprints are built on the Beijing Olympics with the One World theme. They cover people, plants and animals, can be applied to person and product complaints and provides the foundation for globalization, mass customization and personalized medicine.

Enterprise architecture is increasingly seen as the best way to optimize existing IT investment while planning for future growth in areas like green IT, healthcare IT and medical tourism. Only by establishing a blueprint with which to operate can companies comply with corporate and government mandates requiring closer alignment of business processes with IT investment. Further, since change is a constant in IT, the blueprint must be dynamic enough to anticipate and adapt to evolving business models and economic trends.

### Blueprinting and Enterprise Architecture

Enterprise architecture is increasingly seen as the best way to optimize existing IT investment while planning for future growth. Only by establishing a blueprint with which to operate can companies comply with corporate and government mandates requiring closer alignment of business processes with IT investment. Further, since change is a constant in IT, the blueprint must be dynamic enough to anticipate and adapt to evolving business models and economic trends.

Architecture blueprinting is a systematic approach to expressing the organization's complexity in business processes, application components and physical infrastructure via visualization techniques. Visibility and understanding are most valuable when relationships are mapped all the way from top-level business processes to low-level infrastructure details.

### Business on a Page

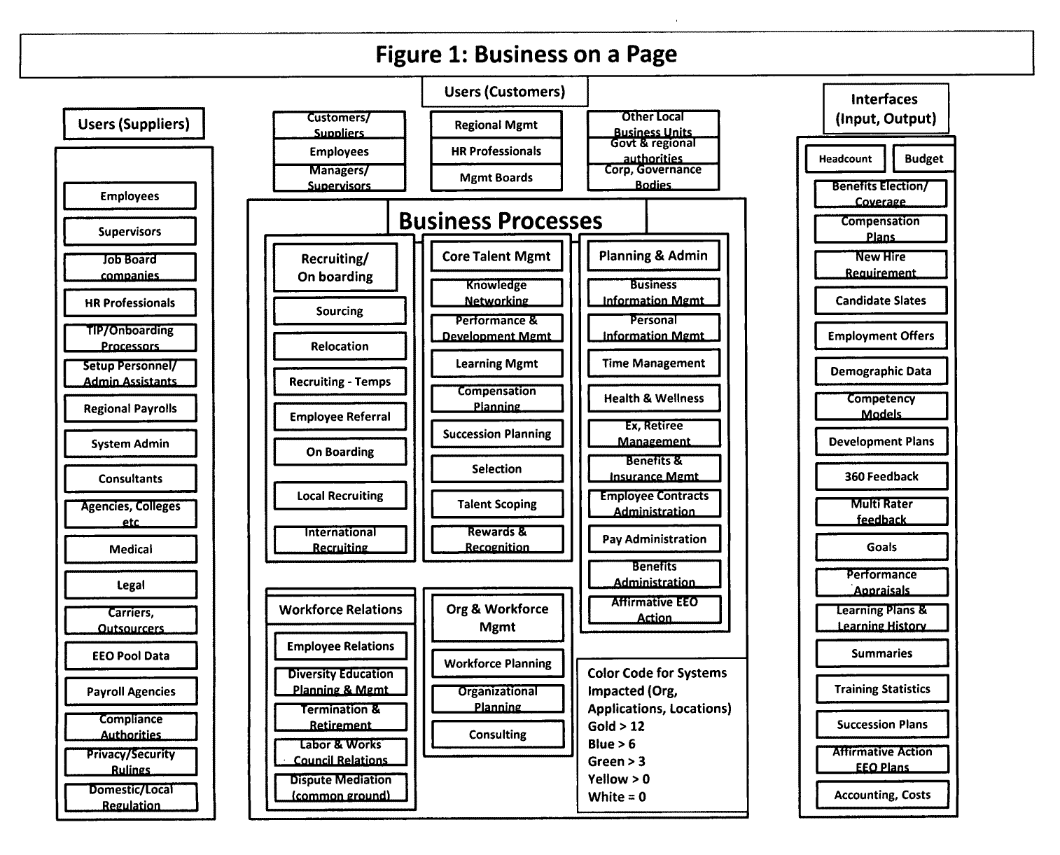

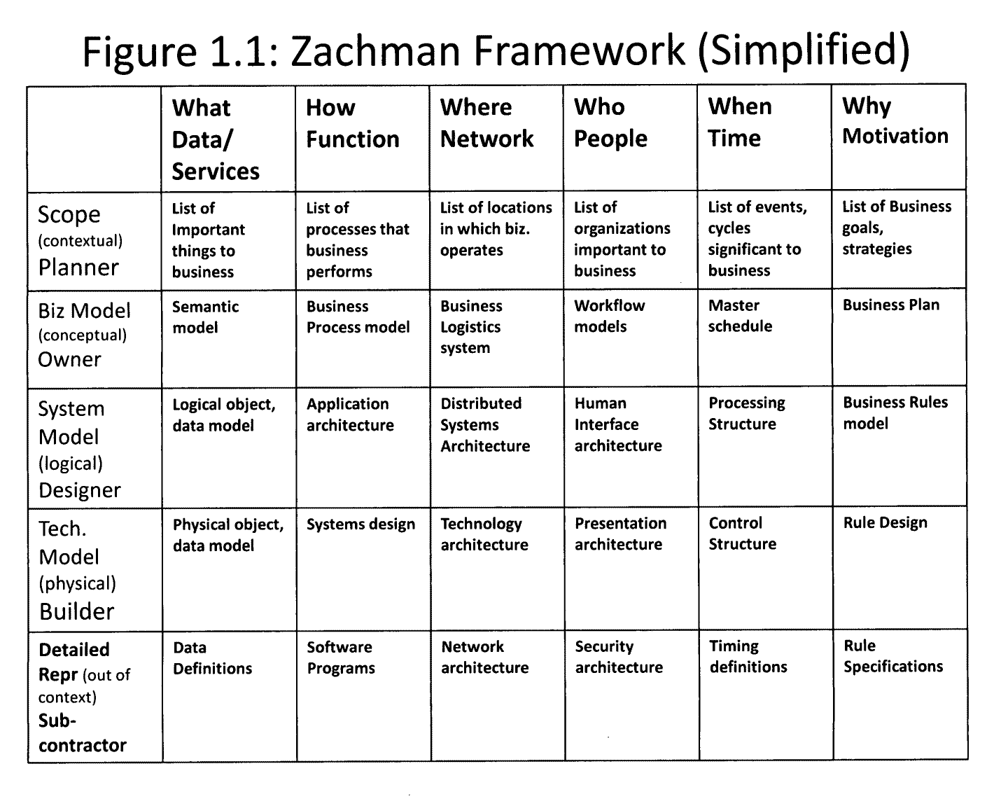

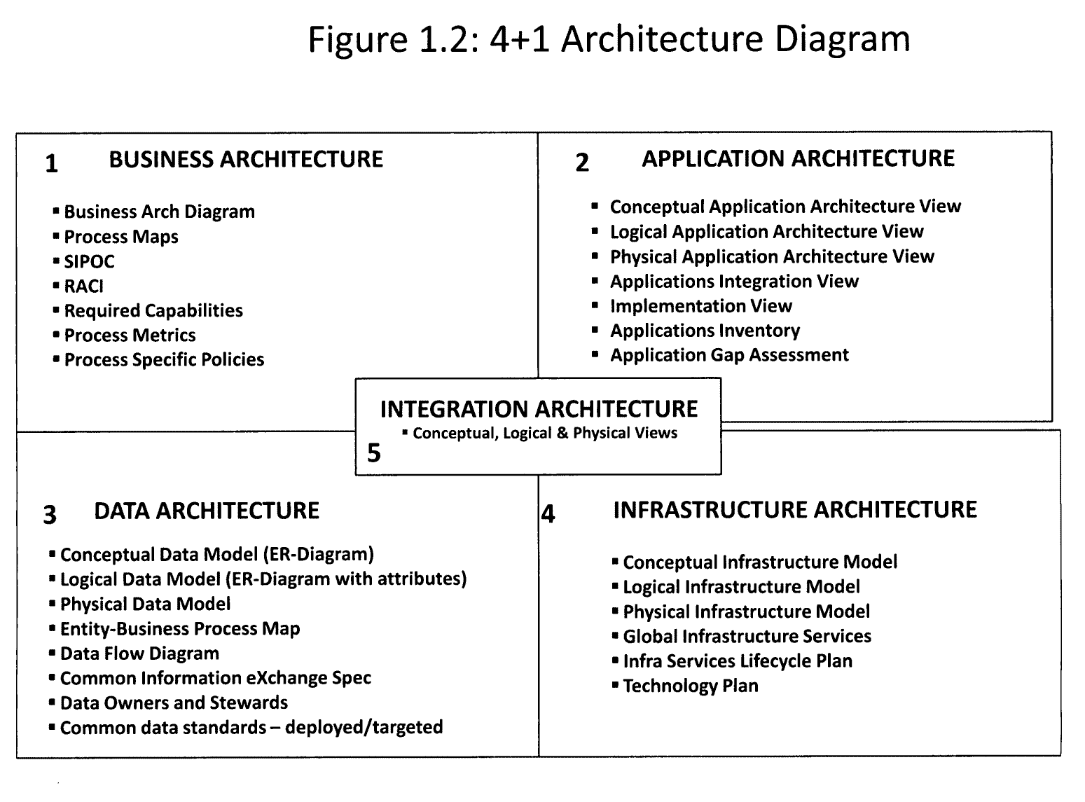

Business on a Page, depicts the core processes needed to support the business functions of the enterprise, its interfaces to its business partners and the location of each of these as shown in FIG. 1. The services are color coded to indicate the number of programs, projects, applications and locations that are needed to support each of them.

### FIG. 1: Business on a Page

Touching or clicking on each of these boxes would show further level of detail that has been captured through tools such as the excel spreadsheet using the Zachman Framework. For example, by clicking or drilling-down on the processes would show the workflows that happen within/across each of these processes and the users (actors) that are involved.

Similarly project/program drill-down would show the number of projects that are impacting each of these processes, their status, cost, ROI, etc. This is necessary to ensure that all the projects being impacted by a certain component are visible to the stakeholders, so that changes in any single one must be communicated to the other. The Perspective Based Architecture dashboards explained later provides more details on the same

The Business on a Page can be also considered as a conceptual diagram for the physical implementation of a personalized portal for the enterprise or for the individual user. It can be used for any life-cycle—be it for a product or for a person. It can be used to understand trends such as the current state of the economy, factors impacting the industry, competition, growing pains, etc for the product, person and enterprise.

Once the solutions that are supporting the Business on a Page are functioning, one can get the status of any of them by clicking on the appropriate boxes. The boxes themselves could change color/size etc based upon the metrics being monitored.

Compliance tools, such as, Six Sigma, SOX, ERP can be leveraged to help create this. FIG. 1 is an example of the same:

FIG. 1 shows the core business processes and services needed to support HR Management & Administration, its users, including customers and suppliers and the major interfaces (inputs and outputs). The color coding and overlays are used to show the organizations, applications and locations being impacted. This second level dependency highlights systems that may currently not be integrated, but should be in the future. HR Processes, including those supporting diversity programs are considered enterprise processes, ie they typically do not change much between industries, organization or locations. Administrative processes in legal, finance & IT are other similar examples.

### Zachman Framework (Simplified)

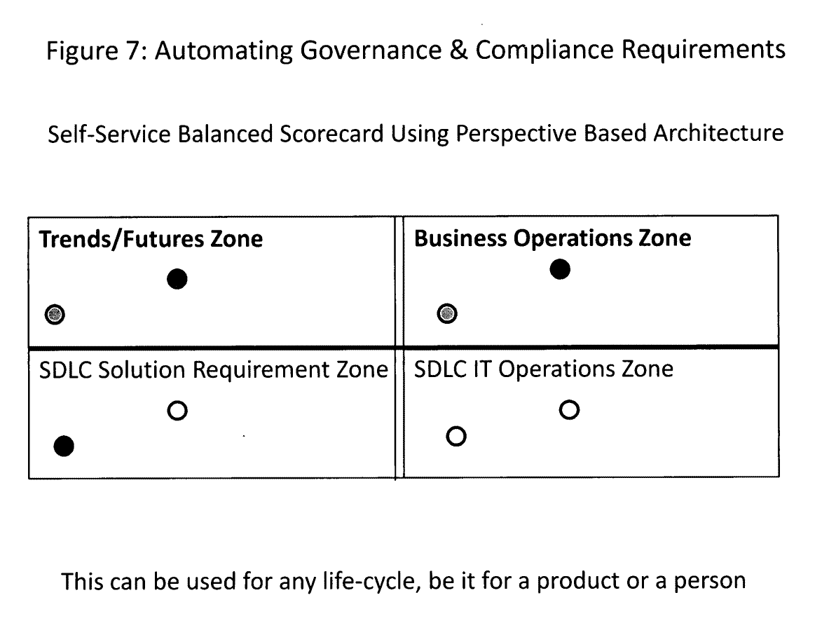

The critical questions of the Zachman Framework shown in FIG. 1.1, namely, why, what, where, when, how and who can be answered through overlays and PBA dashboards as discussed in FIGS. 7-9. In FIG. 1 the color coding shows the number of applications being currently used to support each of the processes. They overlays help in identifying which applications need to be integrated, which need to be consolidated, which need to be migrated, and which need to be retired (after an M&A for eg). The other questions that need to be answered while making these application decisions are explained using FIG. 1.1:

### FIG. 1.1: Zachman Framework (Simplified)

Who: This highlights the industry, organizations & people involved in the scope of the project/program. This includes customers, suppliers, employees and their families and issues such as cultural integration after an acquisition.

Where: This highlights the location co-ordinates down to region, state, zip. For mobile/embedded IT devices, unique identifiers such as IP/MAC addresses should be used.

When: Start Date and End Date (Actual, Planned) for the applications should be available.

What: These show the enterprise processes (services/data) involved in the scope of the project/program.

How: This shows the applications supporting the business on a page. A consistent international standards based taxonomy should be used as discussed later for both planned and actual applications. It should be able to depict the host, hardware, IP subnet, and Service Level/Operational Level agreement metrics and their usage.

Why: This shows the total IT vendor spend, both planned and actual including maintenance costs.

FIG. 1.1 shows a simplification of the Zachman Framework which is considered by many to be the periodic table for Strategy Planning, Design and execution. The rows show the role/responsibilities while the columns show the increasing level of granularity that need to be answered in the various phases of a life-cycle. Enterprise data warehouses will typically show the various columns as dimensions. This is also critical for EA modeling as explained in FIG. 1.2. Business_on_a_Page overlays help answer all these questions as explained in FIG. 1.

### 4+1 Architecture Diagram

5 Architecture components (sometimes referred to as 4+1) as shown in FIG. 1.2 are required to create the unified blueprint using frameworks such as Zachman and explained in Business on a Page. The business architecture layer touches people, processes and location and typically does not have anything to do with technology. Locations of facilities, products, people; processes or workflows by which interaction takes place across individuals, groups, organizations, countries (similar to workflows that happen across machines in a mfg environment); organization structure/roles responsibilities and the governance policies and principles that are in place for the specific processes are covered in this layer. Process metrics, critical success factors, required capabilities including business case/business rationale are also covered in this layer. Inefficiencies of the system (for eg the paper-based workflow that happens across multiple entities, timeshares, regions & countries in the healthcare, real-estate or financial sector) are weeded out through the business architecture layer while creating more effective workflows for personalized needs through remote health monitoring (equivalent of GM*OnStar for a healthy economy).

### FIGS. 1.2-4+1 Architecture Diagram

The technology layer is decomposed into applications, data and infrastructure. The applications layer is typically the software layer showing the various applications supporting the components of the business architecture layer and their interactions (Systems on a page). The business applications layer is supported by the data architecture layer, which needs to include the common information exchange spec UDEF—the symantic interoperability taxonomy that has been adopted by United Nations and can be used to enhance the Internet further through a common reusable repository of objects and governance standards. UDEF is supported by the Open Group and can be used for electronic medical records of homes/cars/people etc that could be automatically generated by IT devices embedded in/on/around these entities. The applications and data layer is supported by the infrastructure layer, which needs to include the wireless standards of connectivity such as Continua by which smart homes, smart cars, smart roads (ie facilities with chips embedded in them) can interact with each other with the right privacy and security requirements to monitor the health of people and products.

The integration layer brings all of these together. Conceptual, logical & physical views of all these layers are needed. An example of the integration layer in the business architecture is diversity initiatives within/across companies. An example of the integration layer in the applications architecture layer is ESB for EAI/Service Oriented Architecture. Universal healthcare coverage for example can be provided regardless of age or employment for a fraction of today's cost through this business model.

### Technology on a Page:

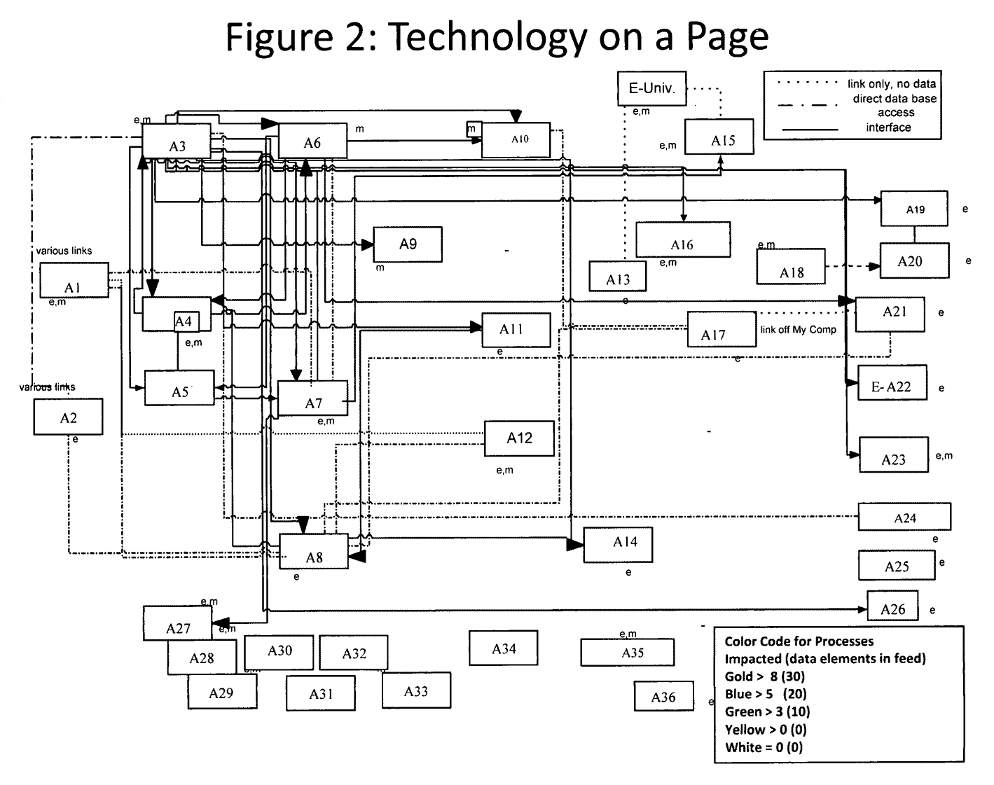

Technology on a Page depicts the applications that are needed to support the business, and their inter-dependency as shown in FIG. 2. The applications are color-coded to indicate the number of processes, programs, projects and locations they impact. The lines are color coded to indicate the number of data elements being passed between the applications. The line-types indicate the type of integration that is being used to transfer data between the various applications. Applications should be identified as internal to the enterprise or as external applications of vendors/partners/suppliers.

### FIG. 2: Technology on a Page:

FIG. 2 shows the applications, their relationships and internal/external connectivity maps. The applications on the left hand side are portal/customer facing applications (A1, A2). After that are the applications that impact the maximum number of processes (left to right in decreasing order). Applications with similar functionality are shown together (eg E-University, A13, A15, A16, A17, A18 are all training related applications). The external supplier applications (or ones which are hosted externally) are typically shown on the far right hand side (eg A19 Benefits links, A24 United Way/Bonds etc). The applications which are not currently integrated even though they impact the same processes identified on Business on a Page are shown in the bottom of the diagram (eg A27 Recruiting, A28 Referral applications).

Further drill down on each of these elements can provide real-time status on the business/person workflow and activities that are being monitored. The Zachman Framework (FIG. 2.1) can be used for collecting the baseline inventory, show the process/events and publisher (source/master) application and the subscriber applications (receiver/secondary).

This system can then be analyzed for closer alignment with business needs as well as IT optimization. System Context Diagram(s), VOC feedbacks & Benchmarking are some of the techniques that we have applied within the Architecture Blueprinting process to help visualize the “future state” architecture, and prioritize the initiatives around the same.

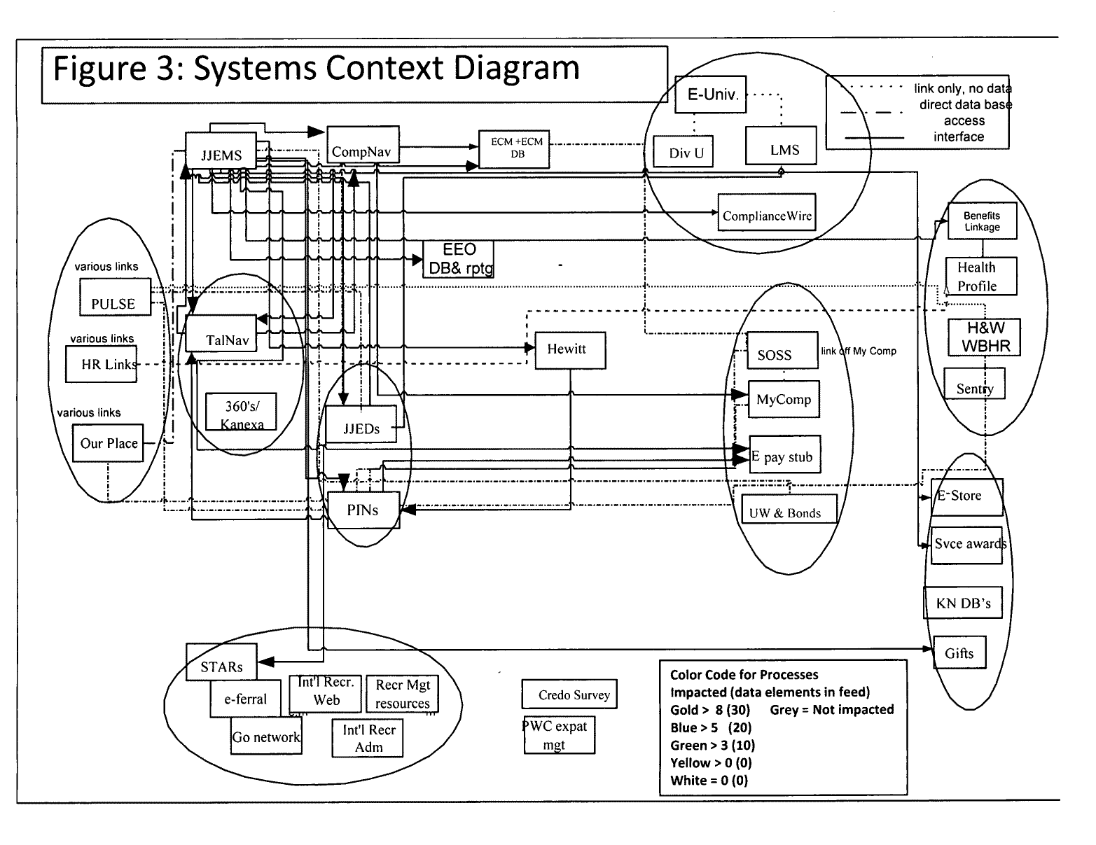

FIG. 3, The Systems Context Diagram(s), link the Business on a Page (FIG. 1) with the Technology on a Page (FIG. 2). By selecting specific components of the Business on a Page, the appropriate areas of the Systems on a Page are highlighted. By analyzing the systems context diagram(s) one can identify patterns. Patterns help identify and prioritize major components of the “future state” architecture. This also gives one the ability to drill down, do impact analysis and scenario planning.

### System Context Diagrams:

Systems Context Diagram(s) link the Business on a Page with the Technology on a Page. By selecting specific components of the Business on a Page, the appropriate areas of the Technology on a Page are highlighted. By analyzing the systems context diagram(s) one can identify patterns. Patterns help identify and prioritize major components of the “future state” architecture. This also gives one the ability to drill down, do impact analysis and scenario planning. FIG. 3 is an example of the same for the core talent management sub-process. Technology tools have begun to emerge with the value proposition of automating the collection and visualization of the various components of the enterprise architecture. Further details on the methodology and the tools/technologies are shown below

### FIG. 3: System Context Diagrams

In FIG. 3, the composite applications have been circled. Left to right are portals/workflow, talent/performance development, identity management, finance/compensation, training/learning, health/benefits, rewards/recognition. The bottom set shows the recruiting/referral applications. Those highlighted in grey would indicate the applications which are being impacted by the Business on a Page but not by the sub-process Core Talent Management currently shown in this example. This may need to be changed in the target state architecture.

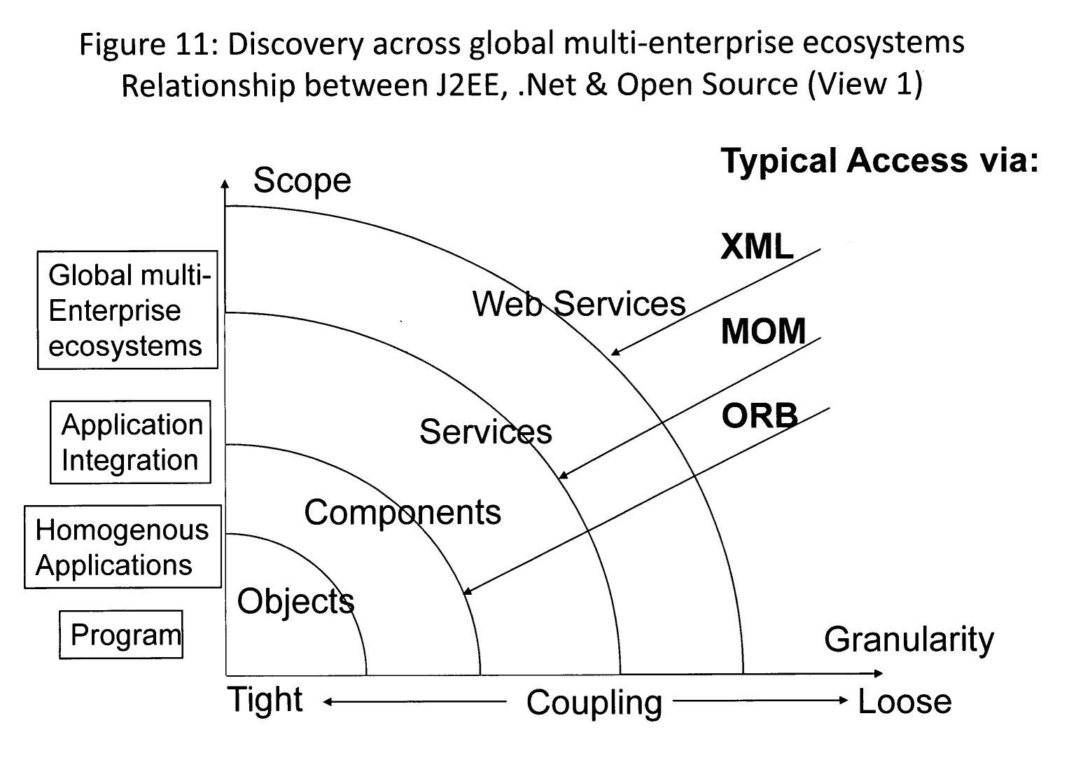

These can be compared for gap analysis with the future state or target architecture shown in the subsequent pages for creating a real-time company that can respond to changes in its environments, competition and customer needs. Example of the same would be the emerging talent shortage when 50% of the workforce retires in the next 5-10 years while meeting the government mandates for green IT, healthcare IT through remote monitoring, personalized medicine and electronic medical records by 2014. Also see FIGS. 11 & 12.

### Federated Service Oriented Architecture for Electronic Medical Records

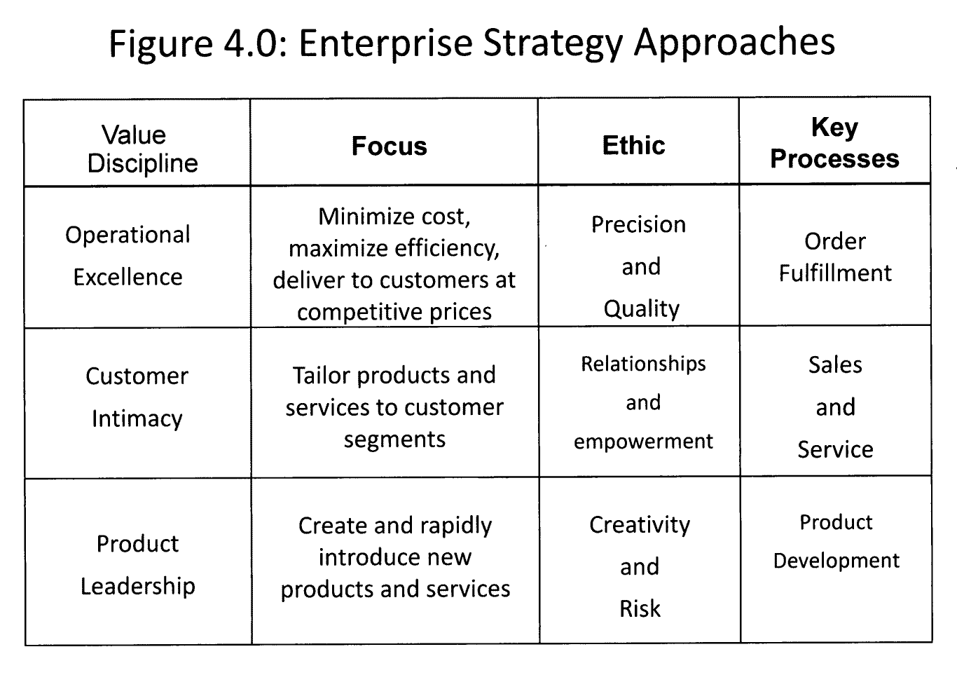

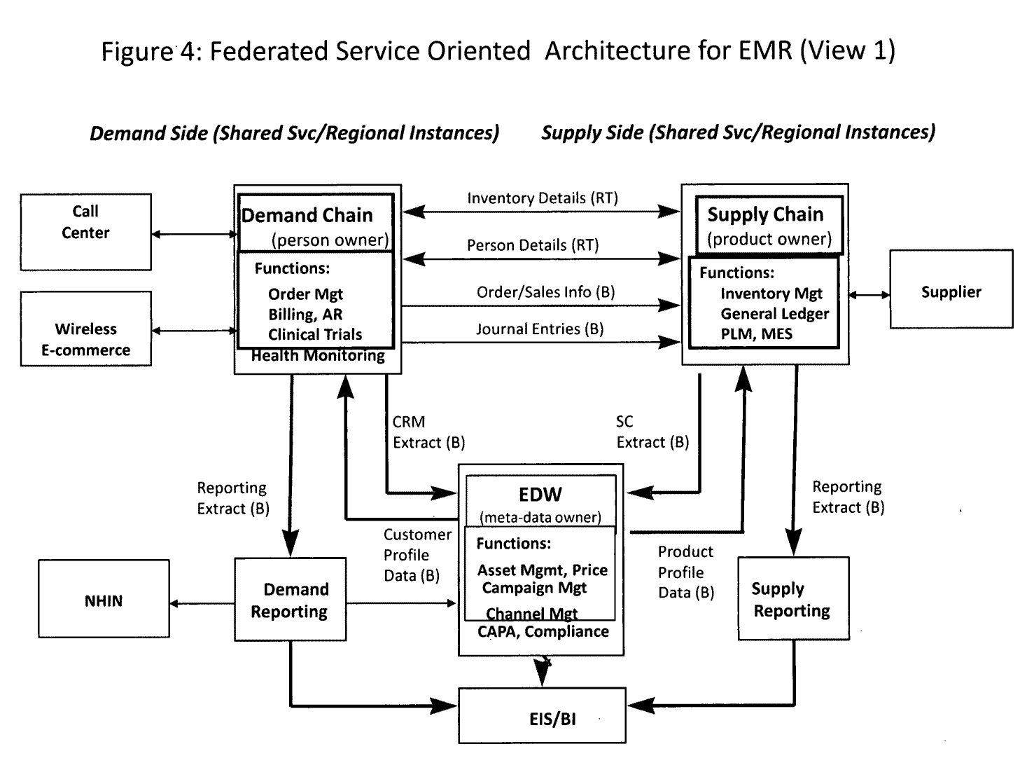

### FIG. 4.0: Enterprise Strategy Approaches

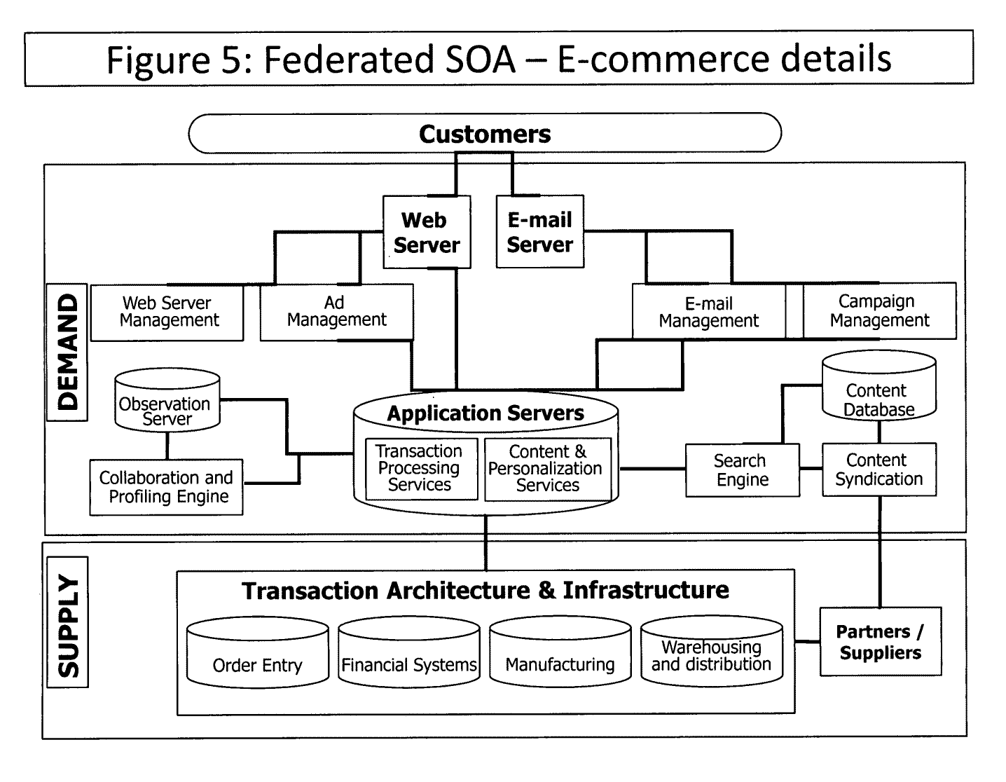

According to a groundbreaking study done in the early '90s by CSC index (FIG. 4.0), companies can pursue enterprise strategies in 3 complementary areas, which cannot be done simultaneously by the same group or organization due to conflicting metrics. The 3 are operational excellence, customer intimacy and product leadership. FIG. 5 shows how companies can structure their business units/business processes to optimize and integrate investments across these 3 areas. Based on these principles the 3 major components of the enterprise architecture need to be built as follows: The Demand Side or Demand Chain or Front Office, Supply Side or Supply Chain or Back Office and an enterprise data warehouse for meta-data ownership which is connected to the National Health Information Network. Business Intelligence or Executive Information System reporting tools using Perspective Based Architecture links the reports from each of these areas. This has been built from an award winning implementation done on a direct mandate for a federal agency which was rated number one in customer satisfaction and saw its order fulfillment rates reduced by 80% and revenues increased by 100% as shown in FIG. 4.

### FIG. 1: Federated SOA for EMR (View 1)

As indicated in FIGS. 4-5-6, Demand Side & Supply Side can be shared services or regional instances

Demand Side connects the customer through multiple channels including the wireless web and call center. The primary functions in CRM/Demand Chain are field service, order management, billing, accounts receivable, clinical trials and health monitoring. Person related information is kept in the CRM databaseSupply Side/ERP connects the supplier. The primary function is inventory management, general ledger, product life-cycle management and manufacturing execution systems. Product related information is kept in the ERP database. EDW gets CRM and SC extracts from the demand side and supply side in real-time or batch mode. It synthesizes this information and provides back the customer profile and the product profile data back to the CRM & SC (ERP) databases. The primary function is asset management, pricing, campaign management, channel management, corrective action/preventative action and compliance monitoring. By moving areas such as pricing into the EDW, companies can begin to move from being product-centric to more customer-centric. Real-Time and Batch information are also exchanged between the CRM and SC databases (Inventory details, person details—RT; Order/Sales Info & Journal entries—Batch). Remote health, environment monitoring information gathered from mobile person and products would be available in real-time through the EDW. Additional details on the various dimensions that would be captured are indicated in the subsequent diagrams.

Electronic signature, medical records and wireless connectivity requirements for clinical and financial interactions when a person/product moves from one location to another would be transmitted using ISO industry standards (Continua/UDEF) to the NHIN. Bioinformatics (genomics) structures of customers will be possible to collect in the EDW using this architecture. Workflow and simulation techniques to analyze how the products may affect the customer-base (eg if the auto, real-estate, insurance, financial and legal services could use it to evaluate new products, ensure compliance and rewards) could now be applied.

Monitoring, governance and compliance at an individual level be it for product or person can be done in real-time through the EIS/BI balanced scorecard explained later.

The Architecture diagram in FIG. 4 builds upon the work done for the US Mint on a direct mandate from VP Al Gore. It was the first time that a government agency won an award for customer satisfaction while competing with the private sector (2^{nd} to Mercedes Benz). See DCI CRM publication by author.

FIG. 5 shows further details of the demand/supply chain architecture for e-commerce. This has been built from the work done for a company that was selected web-retailer of the year.

### FIG. 2: Federated SOA—E-commerce Details

In FIG. 5, The Demand Chain consists of web and e-mail servers. The web server is involved with 1:1 advertisement using the observation server and collaboration/profiling engines are integrated through the application server. The e-mail server is involved with e-mail and campaign management using the content and syndication databases with search engines. The primary services of the application server are transaction processing and content personalization. The application server connects to the supply chain which is responsible for order entry, financial systems, manufacturing, warehousing and distribution. The partners/suppliers are connected to the content syndication databases also.

### FIG. 3: Federated SOA for EMR—Shared Services & Regional View

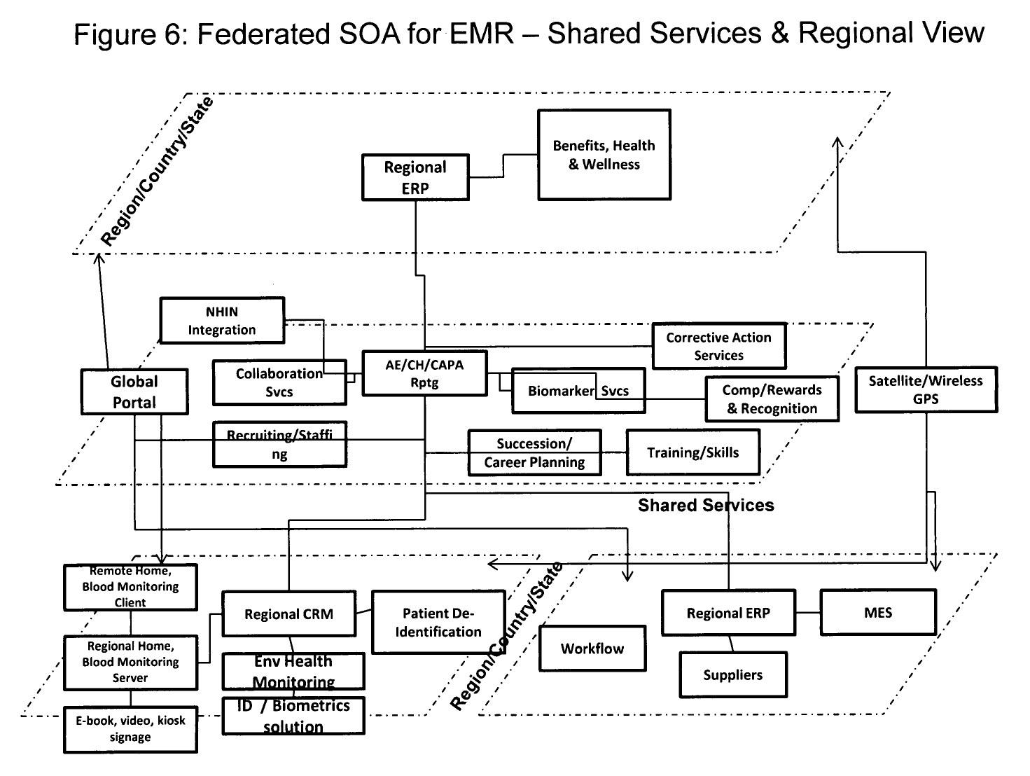

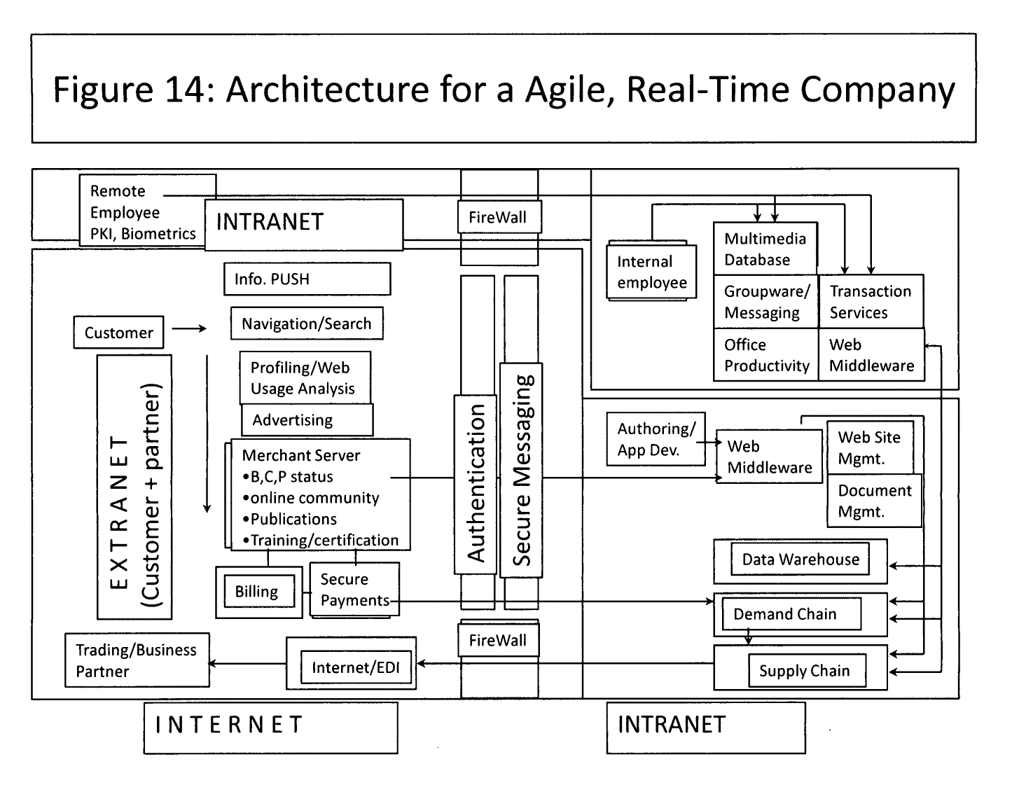

FIG. 6 expands on the work illustrated in FIGS. 4 & 5 and provides an additional view of the real-time architecture discussed in FIG. 14. It can be used as a bi-directional governance model for complaint handling and life-cycle management be it for product, person, plant, animal or environmental health and could be used across states/regions or countries. The shared services show the various dimensions that need to be captured in a bioinformatics database for adverse events, complaint handling and simulation for corrective action/preventative action through self-service portals. These would include biometrics and identity management for security/privacy, collaboration/knowledge management, recruiting/staffing, biomarker services for areas like cancer, AIDS, diabetes, succession planning/career development planning, diversity and university training for skills development and compensation, rewards & recognition for driving behavioral and compliance change.

The regional services show the multiple channels through which the person and product information would be captured. For example in FIG. 6 the US Citizen is in EMEA. The wireless biometrics solution identifies the person. The blood analysis chip for diabetes gathers the diabetic condition of the person and transmits that information to the regional customer database using kiosks or blood diagnostic machines connected securely to the interne. The video signage will provide the person the necessary outputs from the analysis that has been done. For example recommended prescription, its price, directions to the nearest pharmacy, doctor and additional details from the persons EMR. The call centre could call the person immediately if it was an emergency situation, depression etc. Other health/environment monitoring solutions would transmit location specific information to the customer database. Patient de-identification using appropriate regional/local standards would need to be adhered to. Organizing the information using consistent meta-data, taxonomy will be imperative for collecting both structured and unstructured data, so that efficient and effective self-diagnosis can be done wherever possible.

Using satellite/wireless/GPS and rfid/barcodes the person and product information can be transmitted to any region of the world. For example if the person's family/doctor is in North America, they would be able to see the health profile of the patient. Dashboards such as that described in the perspective based architecture diagram would be available to monitor the health and status of the person and product. If they saw a red blip, that would alert them to the fact that the person has an emergency situation. It there is a problem with the product, corrective action would be taken through the product life-cycle management. In the enclosed diagram the product life-cycle management takes place is AsiaPac through 3^{rd} party suppliers. Mfg execution systems would correct the fault in the product being manufactured. Workflow across various supplier organizations using BPM standards would be needed for this.

This federated service oriented architecture would not only address the need of the emerging talent shortage when 50% of the workforce in North America, Europe & Japan retire over the next 5-10 years, but also provide a self-service balanced scorecard for bioinformatics portfolio management through governance, compliance and reward/recognition. This will enable the creation of a real-time environment for personalization and mass-customization using the bioinformatics database connected to the National Health Information Network.

A feasibility prototype to create a 40% faster patient alert system for diabetes using HL7/UDEF was done with the students at Stevens Institute of Technology. Two scenarios (product battery going low, person glucose level going high) were demonstrated. The product scenario was based on the UDEF prototype done for Hurricane Katrina which has received awards both from business and government. Collaboration with FIRST Robotics students from College of Engineering, Pune—India to jointly build on this scenario with Stevens Institute was discussed. Coaching/mentoring of high schools students from Pune and completion of the architecture education workshops for the college students/professors would be need to be completed as part of this prototype. Also see authors paper on “Bi-directional Governance and Life-cycle Management on ongoing work to create a Richmond 2.0 with FIRST/NASA, with academic prototypes and prototype application spreadsheet. It further explains Customer-Driven Health Insurance Coverage Requirements: “Healthy person creates healthy family/organization which creates a healthy economy” which is based on personal experience.

The architecture diagrams outlined here would be able to support the following healthcare insurance requirements. Also see Discover Wellness by Dr Hoffman and youtube video “Energy efficiency—The world in 2030” when the world population reaches 10B+. Air/water quality is predicted to become the single biggest issue by then.

Covers pre-existing conditions (eg depression) & preventative products & services if remote monitoring approved by certified agencies. (EPA/FDA etc). Maybe used for tax deductions and financial aid also.

Air and water quality improvements

Food quality

Home repairs for above mentioned items, energy saving and increasing life-time value

Yoga, breathing (Art of Living) and other approved workouts for physical, mental, spiritual energy and health

Participation in sports, music, dancing, arts & crafts that are currently in Olympics or World Championships

Green Transportation

Mail order of medicine from overseas, if discovered in country of origination (Eg Ayurveda/Homeopathy from India with signed prescription by certified practitioners)

Feng Shui, Veda and other home energy/spiritual energy approved methods

Membership fees for FIRST, YMCA, Scouts and other organizations committed to going green, health & wellness etc.

Time share, real-estate and transportation (even if bought on foreclosure, reduced rates based on life-time value) if it betters the health of the family.

Internet, games, radio & TV shows that increase the wellness of the family

Wireless, interne & security/privacy upgrades to home/office for energy efficiency, health and productivity

Rx Assist Programs

Re-cycling and green activities

Plants & Pets that enhance health/wellness of family

Warranty and health coverage of these products and services

Safe driving and inspection records

Shipment of medicine etc across states

Vitamins, prescription medicine & medical devices coverage increases based on evidence & monitoring

Consumer products coverage increases based on evidence & monitoring

Green, Healthcare Education & Training costs

Reductions in life insurance premiums based on health & wellness index of person and location (eg if a person knows how to swim and is in an area prone to flooding or travels frequently)

Organizing & Cleaning/Reuse activities

UDEF for organizing information/electronic medical records, CFRP11 & NHIN integration

Continua for wireless device interoperability & vibration powered batteries for backup

Billing & Tracking of unreimbursed expenses using a federated national financial architecture (US Treasury, Federal Reserve, banks, credit cards, tax filings etc)

Membership/Travel rewards for creative suggestions & personal experiences of staying healthy while improving families productivity—continuous improvement.

### Automating Governance & Compliance Requirements

Creating a Real-Time Self-Service Balanced Scorecard and Reward System using Perspective Based Architecture

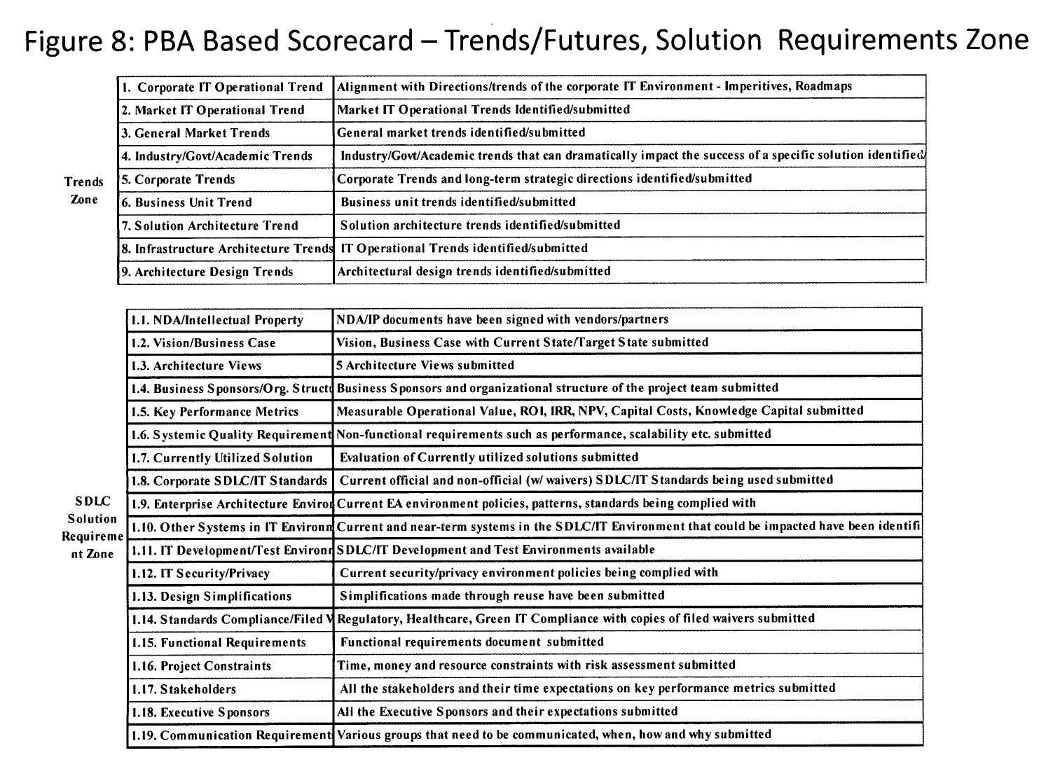

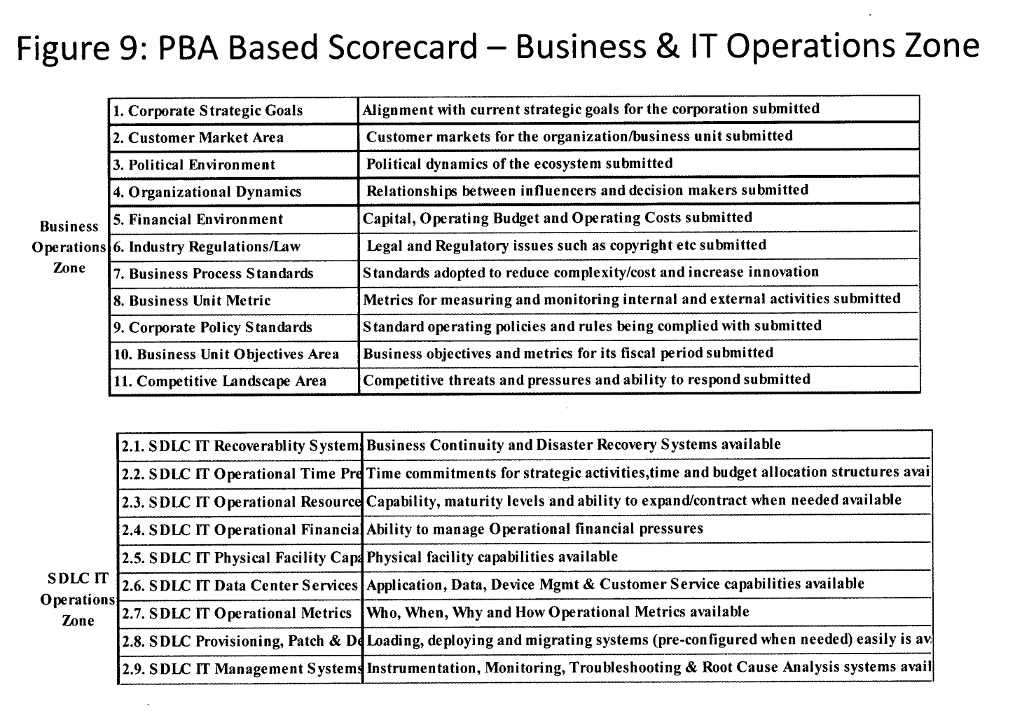

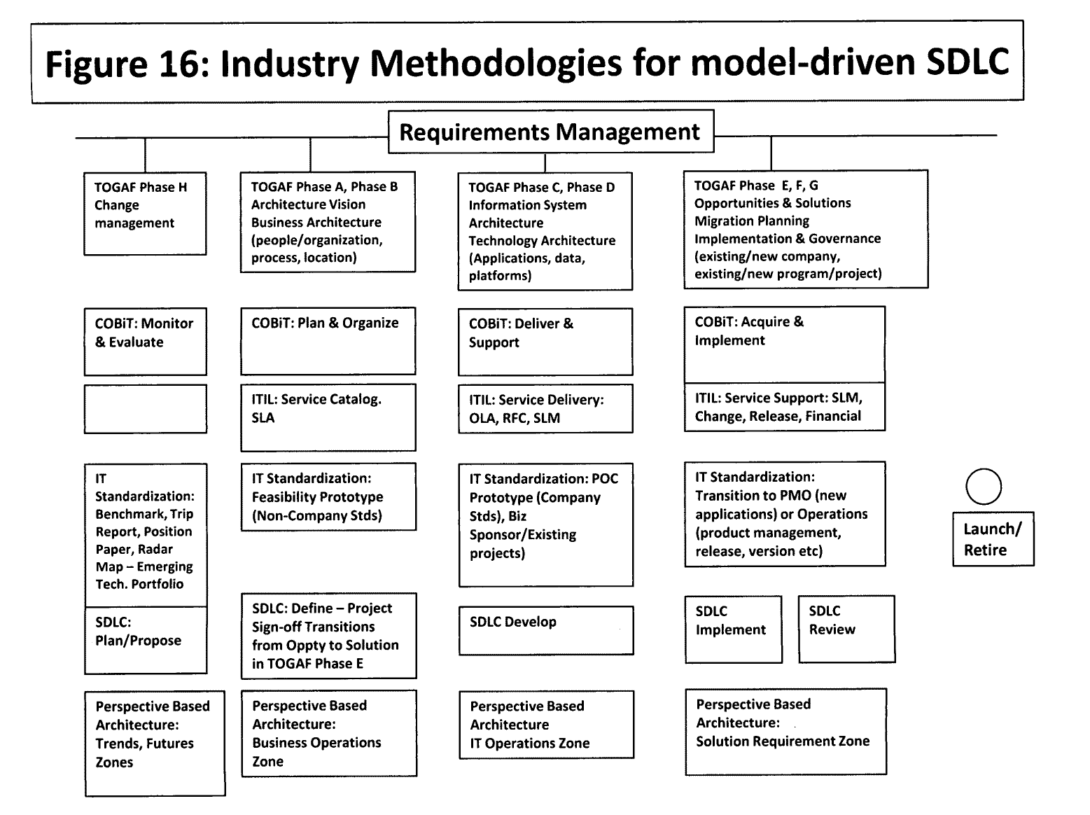

Industry standard methodologies have begun to be accepted globally. ITIL, COBiT, TOGAF, PMBOK provide guidelines and best practices on what activities need to be monitored during any phase of the system life cycle be they for product or person. These life cycles are applicable for any project or program, be they for building financial or insurance products or a car or a home or a community. Monitoring of the environment, competition and customer needs are essential. Perspective Based Architecture provides a list of standard questions that need to be asked during the various phases of these life-cycles. The various industry methodologies provide guidelines and best practices for answering these questions. The mapping between each of these has been done in FIG. 16. By using grading system such as the one in FIG. 8-9, the EIS/BI dashboard shown in FIG. 4 can be further detailed in FIG. 7.

### FIG. 4: Automating Governance & Compliance - Perspective Based Architecture

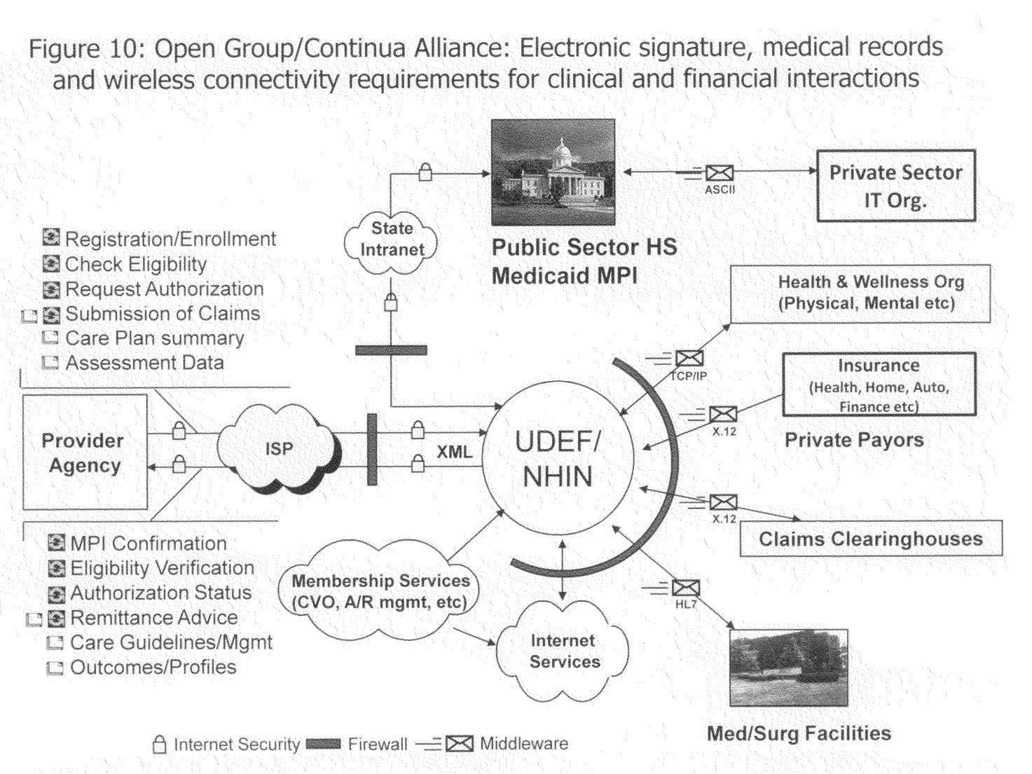

FIG. 7 shows the four quadrants of the PBA that can be used for any life-cycle (person or product). The green, yellow, red bubbles show programs/projects/application status by location (or person, process, service) developed from Business on a Page. It shows the status of each of these as they move through the life-cycle indicated by the 4 quadrants and graded through the PBA grading sheet. The size of the bubble indicates the financial cost. Location of the bubble shows degree of compliance to environmental, government and regulatory requirements v/s ROI. NHIN integration using UDEF (FIG. 10) will be needed to make this real-time.

This is an integral component of managing the human and financial capital portfolio be they across organizations or across regions/countries. Organizations will need to adopt standards such as the ones indicated in FIGS. 4-6. Across enterprises certain standards will need to be followed as indicated in FIGS. 8-9.

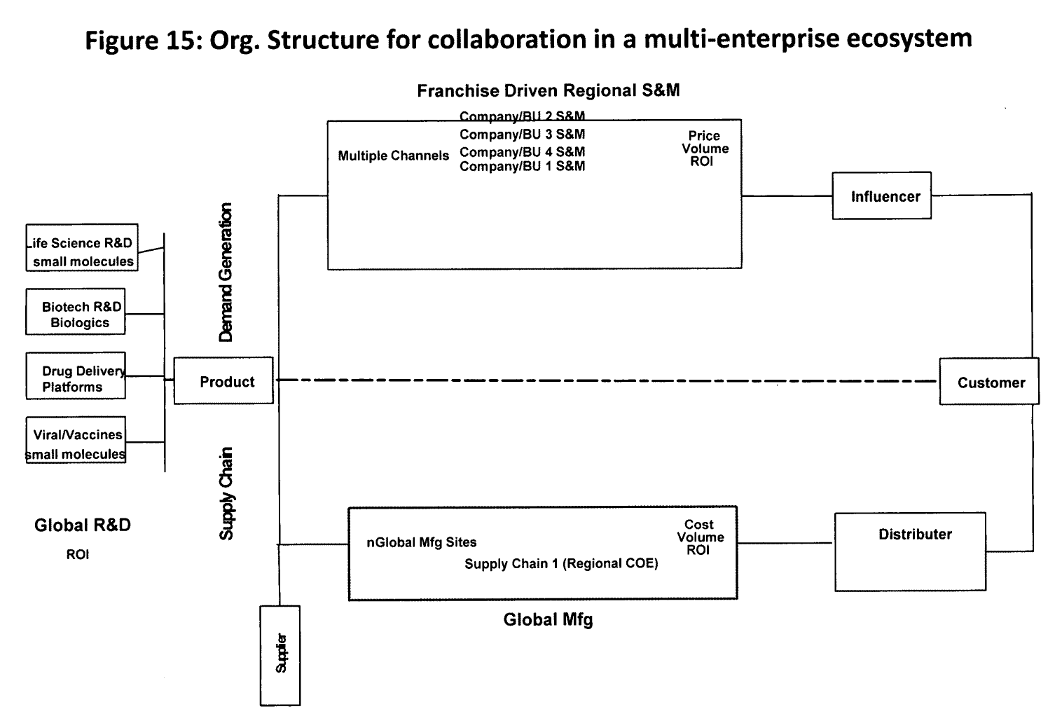

In FIG. 7, the color coding on the bubbles is based upon the answers provided to the questions and guidelines built upon those developed for Perspective Based Architecture. The questions and their descriptions are shown in FIGS. 8 & 9. The SDLC, for any IT project be it for a person or product or an IT product embedded in a person, home, car etc is explained in further detail in the next section and in FIGS. 15-16.

### FIG. 5: PBA Based Scorecard—Trend/Futures, Solution Requirement Zones

### FIG. 6: PBA Based Scorecard—Business Operations & IT Operations Zones

To monitor the economic stimulus package in USA and green grants in other countries a series of questions need to be asked to understand the impact of decisions in a multi-enterprise ecosystem (eg global warming, healthcare, security, credit-rating etc). Also see authors paper on “bi-directional governance and life-cycle management” which is a continuation in part of this patent. FIGS. 8 & 9 show the critical 44 questions that successful architects ask. This benchmark study was done over a 2 year period by architects at Microsoft, and was agnostic to the technologies being used.

The Perspective Based Architecture asks a series of questions that need to answered during the life-cycle process. This also ensures that governance processes have been re-engineered based on the above discussions before automation is applied and those on governance bodies have done their due diligence and are also accountable. Guidelines and expected answers provide a mechanism not only for knowledge transfer while ensuring NDA/IP rights are maintained, but provide a mechanism for proving a concept more cost effectively and efficiently through a consortia of companies and industry verticals, while rewarding talent. It can also be used to increase visibility from the project level to the business level using governance processes such as exception handling and waivers. Ensuring real-time and accurate credit rating of a customer or performance and rewards management of an entrepreneurial employee/sports athlete are examples of how this could be used. Reviews using Perspective based architecture will ensure that reuse takes place while ensuring knowledge management and development of staff occurs at the same time. Knowledge management and reuse will become critical given the aging/retiring population in NA, Europe & Japan and the younger generation replacing them is in emerging countries like India, China, Middle East, Africa. A healthy person creates a healthy family/organization which creates a healthy economy.

FIGS. 8 & 9 show the PBA questions with a brief description and a grading/scorecard is available on the right hand side. The author has also created a series of expected answers to help facilitate the review process. These will continue to get enhanced and UDEF can be used to organize the questions/expected answers and reviews in a multi-enterprise ecosystem. The questions remain the same, regardless of the size/scope of project—whether it be a senior academic project or one for planning smart roads, smart homes, smart cars or the next generation cities. The academic prototype with Stevens Institute of Technology for creating a 40% faster patient alert system by remote blood monitoring for diabetes was done for $5000 at a fraction of what it would have otherwise cost using UDEF/PBA.

### Open Group/Continua Alliance:

Electronic Signature, Medical Records and Wireless Connectivity requirements for clinical and financial interactions.

To comply with the government and legal requirements for electronic signatures, medical records during lawsuits, emergencies such as pandemics, natural disasters industry standards will need to be followed across various companies, for monitoring, governance, compliance and creating reward systems at an individual level, be it for a product or person.

### FIG. 7: Open Group/Continua Alliance—E-Signatures

In FIG. 10, various industries from government, academia and private sector (insurance, finance, auto, healthcare, real estate, transportation, manufacturing, legal, claims etc) have been illustrated that would need to be connected for corrective action/preventative action when the person being monitored at home, in cars etc is affected. Each industry has its own standards for electronic data transfer (HL7, SWIFT, ACCORD etc) Each company has its own IT division. These IT divisions and standards would need to be integrated with the National Health Information Network with appropriate security and privacy requirements. UDEF would be the mechanism for organizing the data, down to the genomics level if needed. UDEF standards would be contributed by academia, business and government as part of the Open Group UDEF Vendor Challenge. This will help create a services registry for effective and efficient search and remote real-time monitoring across different industry standards of xml/edi. For example if a person uses Medicaid funding to finance a legal/law suit, Medicaid should get re-imbursed if the person wins the settlement. Continua is the wireless standard for remotely connecting different devices in/on/around the human body with the appropriate security and privacy requirements.

Thus, as explained in FIG. 6 a person could be anywhere in the world and real-time response to emergency situations would be possible. The feasibility prototype for a 40% faster patient alert system with academia for diabetes was done to meet these requirements.

UDEF provides a set of guidelines and naming conventions for data and objects built on ISO standards. This provides for loose coupling, symantic interoperability and the basis for an UDDI repository which is needed for discovering objects in a multi-enterprise ecosystem (or enterprise 2.0, built on web services 2.0) as indicated in FIGS. 10-12. FIG. 10 also shows the workflow requirements for registration, eligibility, authorization, claim submissions, remittance advice and coverage based on outcomes/profiles. These could be people or device initiated workflows for simulation and remote monitoring/compliance.

Discovery across Global Multi Enterprise Ecosystems
Relationship with open source, J2EE, .NET

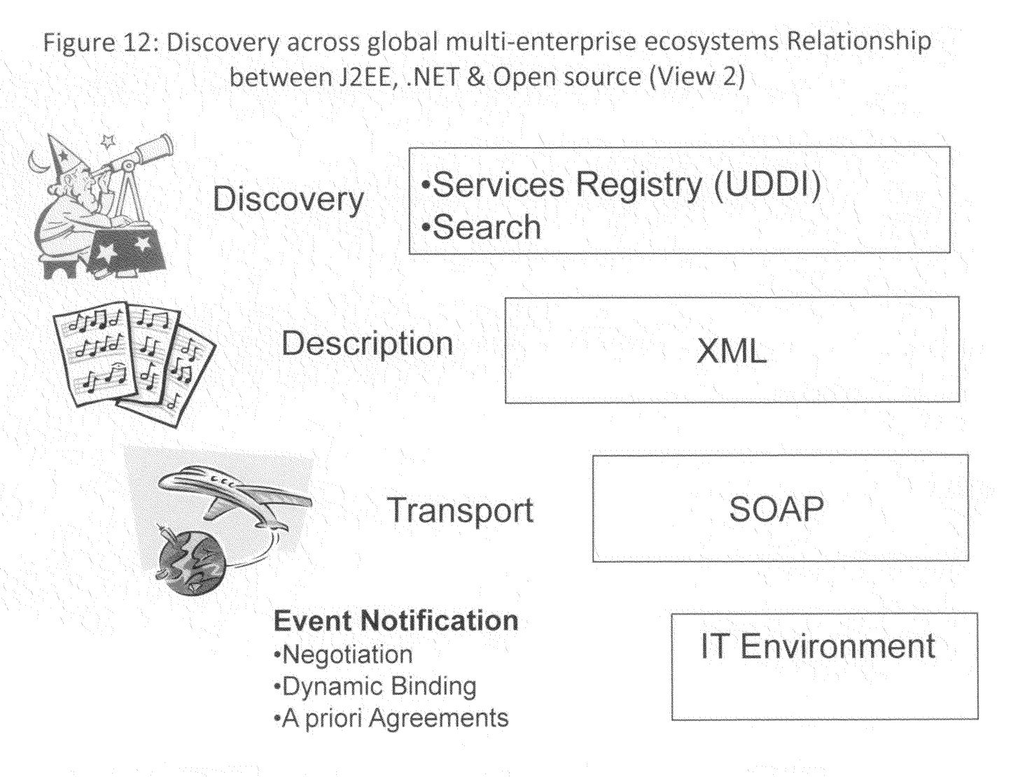

FIGS. 11-12 shows the evolution of e-business (or enterprise 2.0). It illustrates in further detail what Universal Data Exchange Format (UDEF) provides and the basis for a real-time company which is shown in FIG. 14. It shows an example of how integration across multiple industries could be accomplished through UDDI/UDEF with National Health Information Network (NHIN). As IT continues to get embedded in various technologies be they for product, person, plant or animal, best practices from these various methodologies need to be adhered to for portfolio management, governance and compliance monitoring.

FIG. 8: Discovery across global multi-enterprise ecosystems Relationship between J2EE, .Net & Open Source (View 1)

FIG. 9: Discovery across global multi-enterprise ecosystems Relationship between J2EE, .NET & Open source (View 2)

As shown in FIG. 11, 1^{st} generation programs involved tight coupling (eg mainframe applications, IT applications). 2^{nd} generation programs involved integration across homogenous applications (eg applications within same operating systems or same functional areas). 3^{rd} generation programs involved application integration (eg applications across different operating systems including embedded operating systems in non-IT products, different COTS applications). Portfolio management of applications across the entire enterprise, both IT and non-IT applications began gathering importance. Frameworks such as Zachman became valuable to optimize existing IT investments while planning for future growth. 4^{th} generation programs are just evolving. This is forming the basis for enterprise 2.0 and financial/human capital monitoring such as business (patient) activity monitoring using electronic signatures, medical records and wireless/voice connectivity using high speed networks. A services registry for effective and efficient search and remote real-time monitoring across different industry standards of xml/edi (finance, insurance, healthcare, real-estate, transportation, manufacturing etc) becomes critical as shown in FIG. 12.

This provides a further level of detail for the perspective based balanced scorecard that was referenced in FIG. 7. Responses to PBA questions will be matched with guidelines and expected answers that have been set for different industries. And scorecards for bi-directional governance can be created in real-time, similar to the Stevens feasibility diabetes prototype using workflow, monitoring and portals. This integration across J2EE, .NET & Open Source as shown in FIGS. 11 and 12 is required for agile development as IT continues to get embedded in/on/around homes/cars/people etc and is essential for creating real-time companies in a multi-enterprise ecosystem. Along with standards such as Continua, it will allow different devices to interoperate while providing the right security, privacy requirements. This will also facilitate bi-directional governance and even connect with NASA Endeavour & International Space Station to address critical issues such as global warming, air/water quality and pandemics such as swine flue, regardless of whether the website is being accessed from a PC or from devices embedded in/on/around homes, cars or people. It will take Internet search to the next level in a multi-enterprise ecosystem for creating the equivalent of GM*OnStar for a healthy economy. It will drive new business models for areas like green IT, healthcare IT and medical tourism, helping us find cures for cancer, or an engine that does not pollute or a remote blood analysis chip for a fraction of what it would otherwise cost individual companies (See FIG. 15 also).

Life Time Value (person/product)
Example Enterprise Data Warehouse dimensions

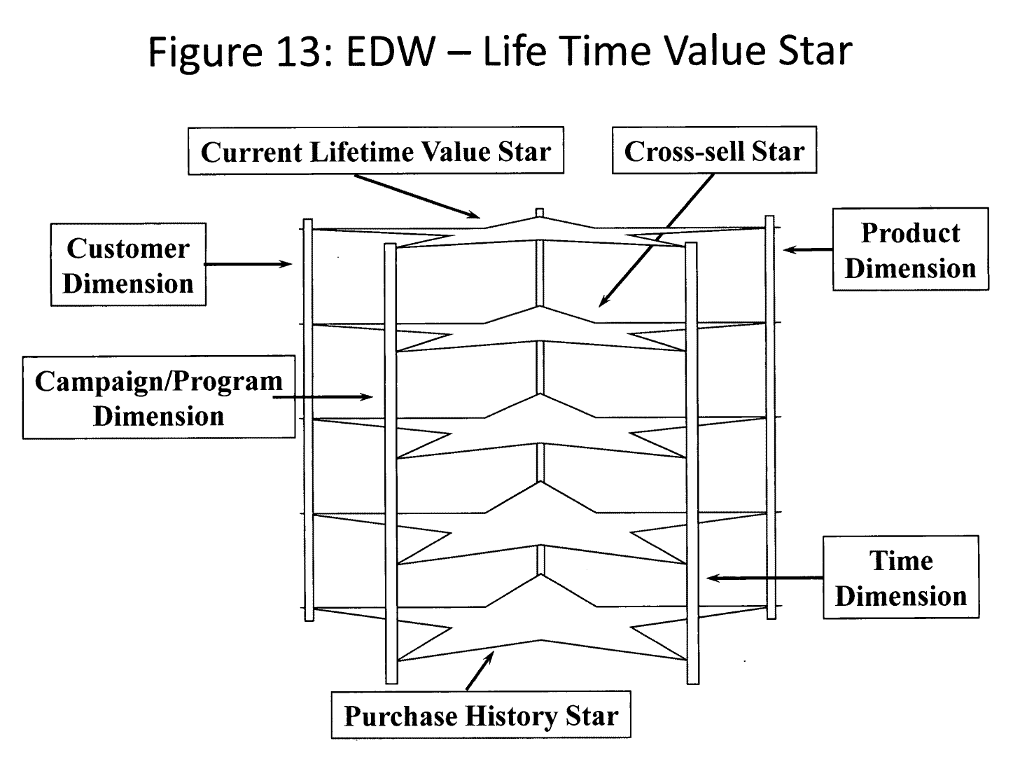

FIG. 13 provides further details on how information being captured across global/regional shared services (FIGS. 4, 6, 10) would look like in the context of an enterprise data warehouse. Note that UDDI provides the capability to get this information from multiple sources (virtual databases) for handling adverse events, complaints and providing corrective action/preventative action either through simulation or in the real-world. (Eg a 3-tier web-services interaction involving a local call (city/company), regional call (state/sector) and national (country/enterprise). Any company that is interested in leveraging large-scale databases containing genome structures of its customers, and wanting to utilize simulation techniques to analyze how its products may effect the customer base (e.g. perfume, auto, real-estate, insurance, financial and legal services could use it to evaluate new products, ensure compliance and rewards by sharing information with other industries) would be interested in this solution.

### FIG. 10: EDW—Life-Time Value STAR

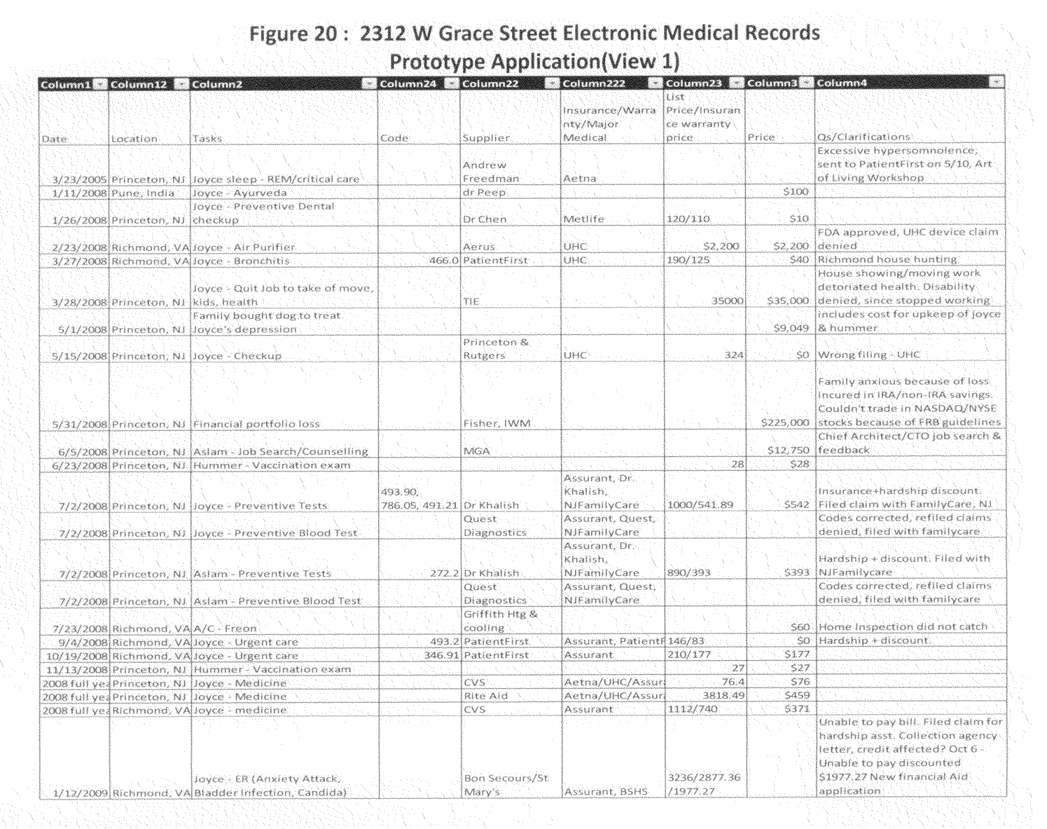

Program/Campaign, Customer, Product, and Time Dimension are shown in this example. Purchase History star and cross-sell star could be created using these critical dimensions. Life-Time Value (person/product), credit rating could be monitored using this schema. This would scale to the genomics level for a person and to an individual parts level for a complex product. It would also scale to products embedded in/on/around people for remote monitoring, personalized medicine and electronic medical records. Programs/Campaigns could be any system development life-cycle. Using operations research and other optimization techniques, models can be created for simulation and monitoring. The prototype 2312 W Grace Street EMR dimensions in FIGS. 20 & 21 is an example of the same.

Architecture for a agile, Real-Time Company

A real-time company is one that can sense and respond in real-time to changes in its environment, competition and customer needs. It has virtual operations or agile linkages of competencies in different organizations when necessary. It is a corporation designed for fast change, which can learn, evolve, and transform itself rapidly. Pulitzer Prize nominee, James Martin called this cybercorp, ie a corporation optimized for cyberspace. Any group or dept within the organization, however small is a microcosm of the organization. Only if all the groups or organizations are synchronized and co-ordinated through the various projects and programs will this become sustainable. The previous steps for internal and external harmonization through integration will need to be completed to become a real time company and part of a multi-enterprise ecosystem.

### FIG. 11: Architecture for a Real-Time Company

FIG. 14 is a summarization of the details of different components of the architecture that were presented in the previous pages. Note that as IT gets embedded more and more in people and products, the intranet components for mobile employees in this example will be in/on/around the human body, as opposed to within the four walls of the organization—the desktop components of the organization are being embedded in people and products in homes, cars, etc and can be used for compliance, governance and reward systems at an individual level. It can be used for remote monitoring, personalized medicine and electronic medical records, also.

Biometrics and PKI are critical for security and identity management of remote employees. Devices in/on/around the employee will be providing emr to the multimedia databases (medical images, electronic signatures etc). Groupware, messaging, office productivity and other collaboration services will be used to complete the transaction through e-mails, workflows using middleware and ESB. This will provide the client side components to business/person activity monitoring. On the server (datacenter) side, similar information will be obtained from customers and suppliers (trading/business partners) by providing personalized services through the enterprise portals. These interactions will be B2B, B2C or personalized to an individual. Online communities, publications and training certification will provide the critical components for e-learning and collaboration, through devices like Amazon e-books and Apple i-phone. They will also provide the basis for the customer to take corrective action/preventative action when something changes in the environment. The Demand Chain provides the e-commerce capabilities such as billing and secure payments. Web middleware provides the integration to the data warehouse, demand chain and supply chain. The SOA governance repository of the web-middleware would be UDEF compliant per the previous diagrams. The supply chain would have agile linkages into suppliers' organizations through the internet webs services for messages and edi for large file transfers. Authoring/Application Development tools become critical enabler of model-driven architecture and ensuring compliance between documented designs and final products. CAD/CAM is an example of the same in the mfg industry. Firewalls, authentication, authorization and levels of security across the internet, extranet and intranet that would be needed for requirements like 2 factor authentication need to be satisfied. Document management which takes care of structured and unstructured electronic records will be a critical dimension of the EDW. Customer profiling and web usage analysis are used for advertising and cross-sell/up-sell opportunities based on customer or product life-cycle history. Trading/Business Partner could be a customer also and the architecture should support the same. RFID is an excellent example of the first step that companies have begun to take for becoming real-time. The infrastructure that RFID requires provides a foundation for organizing and collecting even larger volumes of information that will be coming through electronic medical records and biotechnology/genomics.

As mentioned above it is critical to co-ordinate and monitor the progress in people, process and technology life-cycle in real-time through the various programs that are in place within the organization. The Perspective Based Balanced Scorecard and its four phases described above gives the basis for that dashboard. The reporting comes from the EDW. The various life-cycles that it monitors is shown in FIG. 16.

All credit card/check/bank billing transactions go through the central banks of countries (Federal Reserve System in the US) and can be used for billing and tracking of expenses at a fraction of what it costs companies today while creating e-receipts (going paperless for credit card receipts etc) as shown in FIG. 14. This can be used for financial aid and tax purposes also. Rewards Management & compliance solutions for health & wellness (eg preventive health insurance coverage across countries) can now be created in a global multi-enterprise ecosystem. This will also help create a financial infrastructure for mass-customization, personalized medicine, credit rating and create new business models for areas like green IT, healthcare IT and medical tourism. This will also support electronic medical requirements through e-signatures, be it for person or product (home, cars, time-shares etc) and automated generation of EMR by devices in/on/around the human body (equivalent of GM*OnStar for a healthy economy). The prototype 2312 W Grace Street EMR in FIGS. 20 & 21 is an example of the same. A healthy person creates a healthy family/organization which creates a healthy economy.

From idea (molecule) to market
Organizational structure, Electronic documents workflow and medical records for a real-time bioinformatics company

FIG. 15 shows the federated organizational structure, roles/responsibilities, customer touchpoints and metrics that can be used by creating centers of excellence to reduce time to market and cost of creating a new product. The components discussed in FIGS. 4.0, 4, 6, namely demand chain, supply chain and EDW (R&D & Marketing) can be accordingly aligned and the portfolio of projects across various companies can be monitored. Advisory Boards with linkages to govt., business and academia are recommended.

FIG. 12: Org Structure for collaboration in a multi-enterprise ecosystem

1. Global R&D is shown on the left. Companies specializing in R&D are collaborating in this area. The money saved from automating paper-based medical records could be put back into R&D for knowledge transfer through FIRST Robotics, creating a cure for cancer, an engine that does not pollute or a blood analysis chip Creativity and risk management metrics for product leadership should be the key ethics.

2. As the product/solution is being developed the infrastructure for demand chain and supply chain need to be separate but developed and monitored in parallel. The supply chain is primarily focused around global manufacturing sites and product life-cycle management. Close linkages with the distributers and 3^{rd} party suppliers need to be in place not only to create cost effective products, but also to take corrective action/preventative action on return goods, etc. Precision and quality management for operational efficiencies should be the key ethics.

3. The Demand Chain is focused around demand generation and price which can be region/customer specific and based on volume also. Close linkages with influencers, be they in government, business or academia need to be created, for customer intimacy, loyalty/trust and customer life-cycle management. Multiple channels of sales and marketing need to be co-ordinated across various companies through centres of excellence. Relationships and empowerment for customer intimacy should be the key ethics.

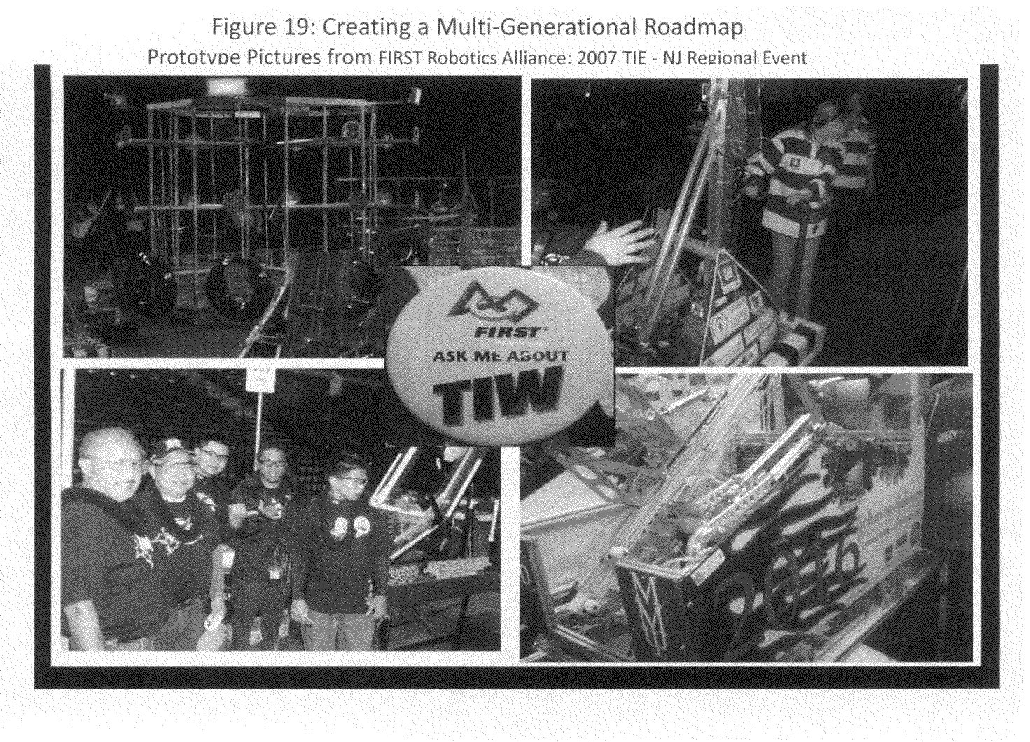

This separation of roles/responsibilities is based on the ground-breaking study from CSC referred to in FIG. 4.0. This is a phased approach to creating real-time company, especially in situations where the enterprise may have a portfolio of companies through organic growth or M&A. It is needed to get products to markets globally at a fraction of the cost than what is available today (eg: in pharmaceuticals it costs over $1B and more than 8 years to get a product to market). Enterprise processes such as HR, Finance, Legal, IT do not change much across companies and need to be harmonized across all the companies. Multi-generational programs based on FIRST Robotics can be used to get products to market at a fraction of the cost/time as explained later. The prototype discussed in FIG. 19 is an example of the same.

### Mapping Industry Methodologies.

Several Industry methodologies have evolved globally for system development life-cycle. As IT continues to get embedded in various technologies be they in a product or a person, best practices from these various methodologies need to be adhered to for portfolio management, governance and compliance monitoring. The same principles and guidelines that apply to an IT project, would apply to a nuclear power plant or an automobile or city planning or agriculture or sports as the customer gets woven into the fabric of a multi-enterprise ecosystem.

### FIG. 13: Mapping Industry Methodologies

A real-time organization needs a SDLC that can keep it aware of all the changes taking place within the organization. How long does it take before an emerging trend or an idea can be spun off into a new company? What will get impacted before a product/person retires? Effective and efficient governance for life-cycle management become critical in a real-time company (see authors paper on the same). Knowledge management and knowledge transfer are critical elements especially since 50% of the workforce will be retiring in the next 5-10 years in NA, Europe & Japan. Collaboration across academia, government and business needs to take place for moving ideas to market at a more cost effective mechanism than what is available today. For example if a product costs “x”, by the time it reaches the consumer it may cost “4×” or greater. The next generation will not be able to afford the high-costs in areas like education and healthcare for themselves and the aging population. Consumers in emerging markets need to be able to afford the costs of these new products/services for a greener, healthier environment and medical tourism. An infrastructure that can support the requirements of remote health/environment monitoring, personalized medicine through bioinformatics and electronic medical records is needed. This extended internet needs to be “always on” for emergency response so areas like backup for electricity/battery, wireless reliability, security, performance etc, in these devices is critical. Governance becomes critical which is explained separately in Bi-directional Governance & Life-Cycle Management continuation in part patent filed on Sep. 21, 2009. The SDLC needs to ensure that entire organizations/industries/cities do not disappear due to lack of quality and compliance from a single individual or loss of knowledge due to the upcoming baby boomer wave.

In FIG. 16 the IT standardization row builds upon best practices from various methodologies and provides a four phased approach that begins with Business on a Page (FIG. 1) to taking a new product/company to market, through feasibility prototypes. These feasibility prototypes are based on non-company standards and are typically done in collaboration with academia through the FIRST Robotics/UDEF/Continua alliance (see FIG. 19). If the feasibility prototype succeeds then individual companies of the alliance (be they in government, business or academia) will do a proof-of-concept (POC) using their company specific standards and by finding a company business sponsor. Doing the POC as part of an existing project/program should be reviewed before spinning this off as a new project. If the POC succeeds than it can follow one of two paths. If this is an upgrade to an existing project/operation/property/automobile etc., it would go to operations or be bought by a company specializing in that area. If this is a new project/application it would go to the Program Management Office and/or create a new industry/sector. Once it is successfully completed the new product/person/sector is launched. This could be done through the formation of a new company or a new industry. This would typically entail the retirement of an old product/person/company/industry per the system development life-cycle process.

The Perspective Based Architecture asks a series of questions that need to answered during the life-cycle process as explained in FIG. 7-9. Guidelines and expected answers that the author has created provide a mechanism not only for knowledge transfer while ensuring NDA/IP rights are maintained, but provide a mechanism for proving a concept more cost effectively and efficiently through a consortia of companies/industry verticals.

FIG. 16 shows how the Open Group UDEF Vendor Challenge for electronic medical records can be used for taking a new idea/company to launch/acquisition through non-company standards. A feasibility prototype for remote blood analysis for creating a 40% faster patient alert system for diabetes was done with Stevens Institute of Technology where PBA was applied. The prototype was done for $5000, a fraction of the cost that it would have typically taken if these principles had not been applied. Organ transplants such as kidneys need constant blood monitoring, as do early detection of diabetes, AIDS, Cancer. Similar devices can be embedded in homes for monitoring not only the environment and health of the home and automobiles (water, electricity, smoke etc), but the health of the people living within. By using open industry standards when the people move/relocate, finance and insurance providers will have the necessary information for personalized portfolio management, simulation and providing real-time quotes based on past history and medical conditions. This will provide incentive for people from all over the world to come to countries that have the most cost effective infrastructure for areas like education and healthcare and create new business models for medical tourism.

### FIG. 14: IT Projects and SDLC

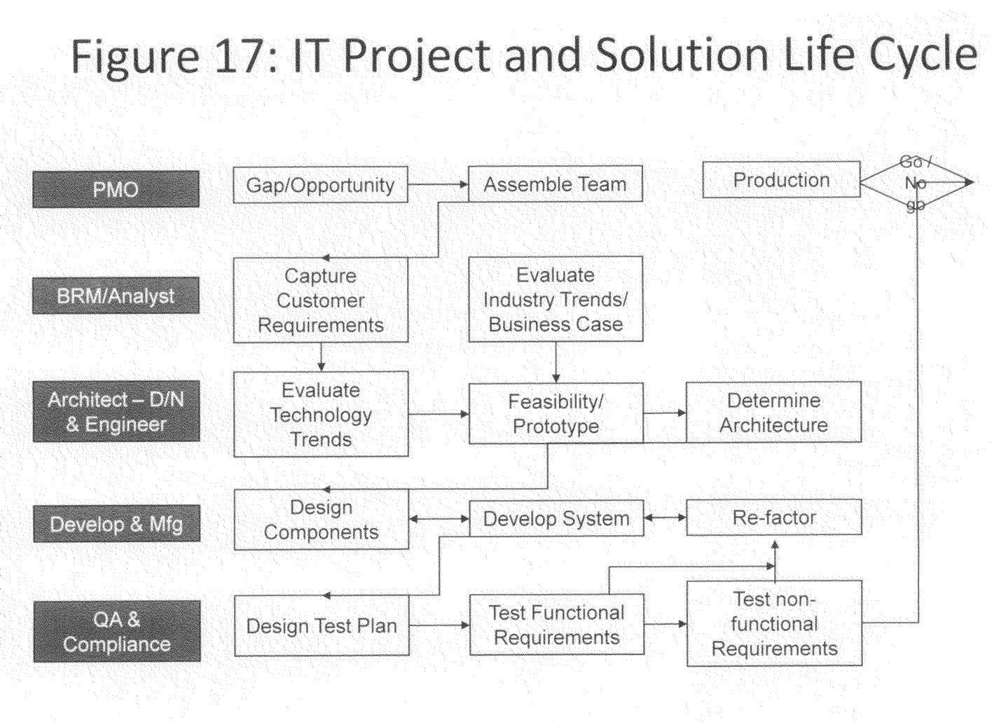

FIG. 17 illustrates the roles/responsibilities and workflow through the phases shown in FIG. 16 for any IT project, including those that embed IT devices in/on/around people, homes, cars etc. The questions that are asked during the 4 phases of the PBA need to answered during the 4 phases identified in this diagram. It would apply to the Business and Technology layers of the architecture for enterprise (technology-neutral, non-company standards) and solution architecture (technology specific, company standards). The dashboard shown in FIG. 7 would monitor the progress within the SDLC. If the Q&A and workflow are automated through the UDDI governance repository, automated reports would be possible.

### FIG. 15: Integrating Users in SDLC

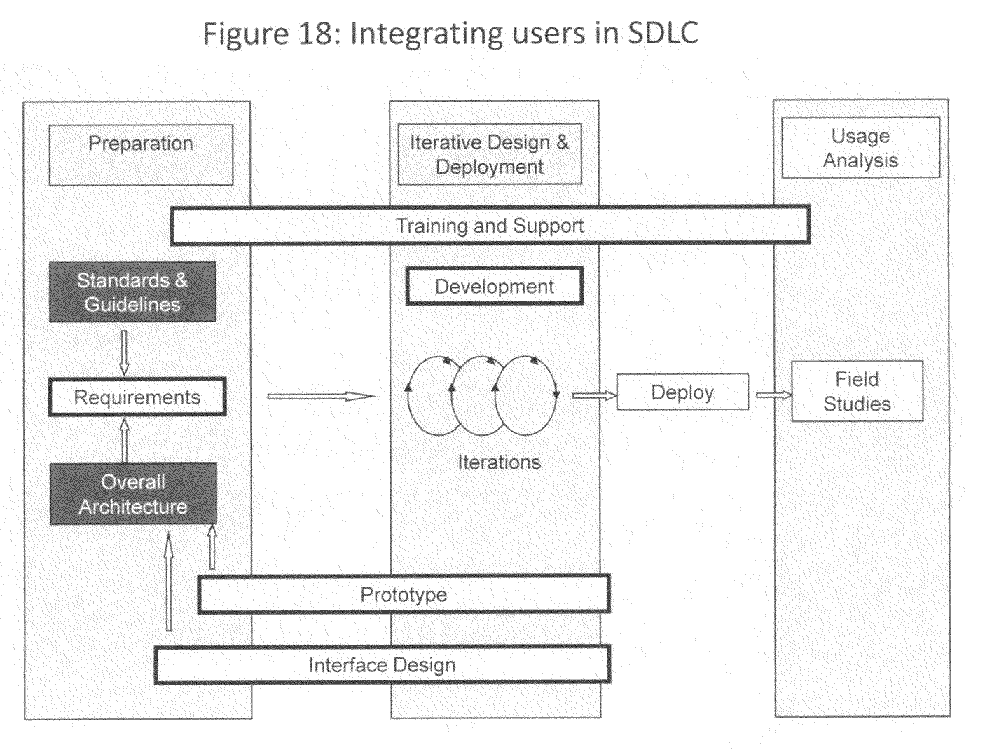

FIG. 18 illustrates a related view showing when and how users need to be integrated into the SDLC be it for a person or product or a product embedded in a person, home etc. Training & Support, Prototyping & Interface Design should begin during the early stages to ensure that customer requirements are being met. Standards & guidelines and overall architecture need to be used for multi-enterprise ecosystems such as that needed for medical tourism. Model-Driven Architecture lends to iterative development from the blueprints that have been created for Business on a Page. Iterative development typically uses scenario planning to identify the scope & phases of development. Usage analysis from field studies provides continuous feedback and monitoring to refine the product and take corrective action/preventative action. Eventually simulation can be done for new product development in areas like mass-customization and personalized medicine across companies also through a publish-subscribe model. The EA Innovation workshop with academic prototype costs about $80,000, internal proof-of-concepts about $250,000 and complete implementation of the bioinformatics dashboard about $10M. Participants from business, government and academia with the Open Group consortia should be present to make more effective use of the economic stimulus package in US and green grants from other countries while moving the Internet to the next level through a UDDI-type global repository based on UDEF that United Nations has adopted (this will have a similar impact as Unix did for client/server computing) The author was a founding member at the MIT spinoff CTP that helped commercialize Unix with the Surround™ architecture.

### Creating a Multi-Generational Plan (Roadmap)

### Using FIRST Robotics and Regional Entrepreneurial Network

The FIRST Robotics provides an opportunity to ensure we have sufficient talent in North America, Europe & Japan, when 50% of the workforce retires over the next 5-10 years while having the aging population mentor/transfer their knowledge experience to this younger generation in other parts of the globe. This is imperative for ensuring we have sufficient educated talent, passion and fashion using cost effective channels. In return, the younger generation will address the biggest need for the aging population ie rising cost of environment, healthcare and the government mandate for health care IT, green IT and electronic medical records (US has mandated EMR for all US Citizens by 2014 with a projected annual savings of $160+ billion dollars to corporate america).

FIRST Robotics (www.usfirst.org) can be used to get high-school students and colleges across the globe interested in enterprise architecture, biotechnology and entrepreneurship at an early age, and provide them an opportunity for multi-cultural experience in a safe-secure environment by visiting countries like USA that are facing retirement issues. US universities give credit to students who have participated in this program when they apply for admission/scholarship etc. Some of them may go on to find a cure for cancer or an engine that does not pollute, or a solution for global warming.

These high-school students will need mentoring from business, government and academia. To prepare the mentors for collaboration Enterprise Architecture & Innovation training courses in academia (40-90 hours, including the feasibility prototype) for engineering, medicine and management classes built on TOGAF will be offered. These will be customized with specific examples/case-studies from prior engagements and work done in HR, Finance capital management and health care compliance. It will include material such as the diagrams being patented which are built on the Beijing Olympics with the One World theme. One of the next steps from these workshops would be to get them acquainted with FIRST (global robotics program) & Robocon (eg of a regional robotics program in India) and use these partnerships to help build a feasibility prototype as part of the senior design projects. This would be demonstrated through the Open Group UDEF Vendor Challenge, which provides a faster and cheaper alternative to take ideas and standards from academia to govt and industry globally using concepts such as time share and microfinancing. UDEF is the equivalent of a universal language and data translator. It was used in a prototype for a emergency response scenario for Hurricane Katrina that involved the US Post Office. It has been adopted by United Nations also. Census metrics such as the US Census statistics for our communities will be a good metric to measure the progress. The work done as part of the UDEF Vendor Challenge would become a critical component of the UDEF UDDI repository. It would provide an opportunity to collaborate with ongoing biotech initiatives between USA universities such as Stanford/MIT and governments of emerging markets with a pool of talent not facing retirement issues such as India.

Advanced Workshops in EA & Innovation for sponsors of these teams would be provided at client locations. These would be similar to EA/TOGAF curricula, but would be at client locations and shorter time frames. Preliminary work may be done to gather client specific issues which would be discussed during course for the education workshop. This could be followed with a 3-5 week architecture & health care compliance phase to create a migration plan for the target state architecture. One of the next steps would be to use the FIRST/Robocon partners to help implement the feasibility prototypes done in academia to their specific company requirements.

As part of the ongoing work for a Richmond 2.0, a prototype of this is being planned in Mumbai/Pune, India. to create a Mumbai/Pune 2.0 since Richmond residents were affected in the terrorist incident in Mumbai over 2008 T' giving. This could be modeled globally for green IT, healthcare IT and medical tourism, using industry best practices and open standards as discussed above.

In summary, the figures above and multi-generational program explain how innovation can be driven, while reducing the cost of living, ensuring sustainability, reducing healthcare costs, improving productivity and global talent management when the world population reaches 10B+ in the next few decades.

### Prototype Pictures and Electronic Medical Records

The subsequent figures, pictures and electronic medical records with e-signatures including those in the claims section provide more details on the prototype application of my patent.

### FIG. 16: Creating a Multi-Generational Roadmap

FIG. 19 is a prototype example of the multi-generational program outlined above from the 2007 TIE-NJ Regional event that the author participated in. It builds on the FIG. 1.2 explained earlier for developing the next generation talent. Some of these kids will grow up to become Presidents of countries and companies and help create the equivalent of GM*OnStar for a health economy.

### FIGS. 20 & 21: 2312 W Grace Street Electronic Medical Records (View 1 & View 2)

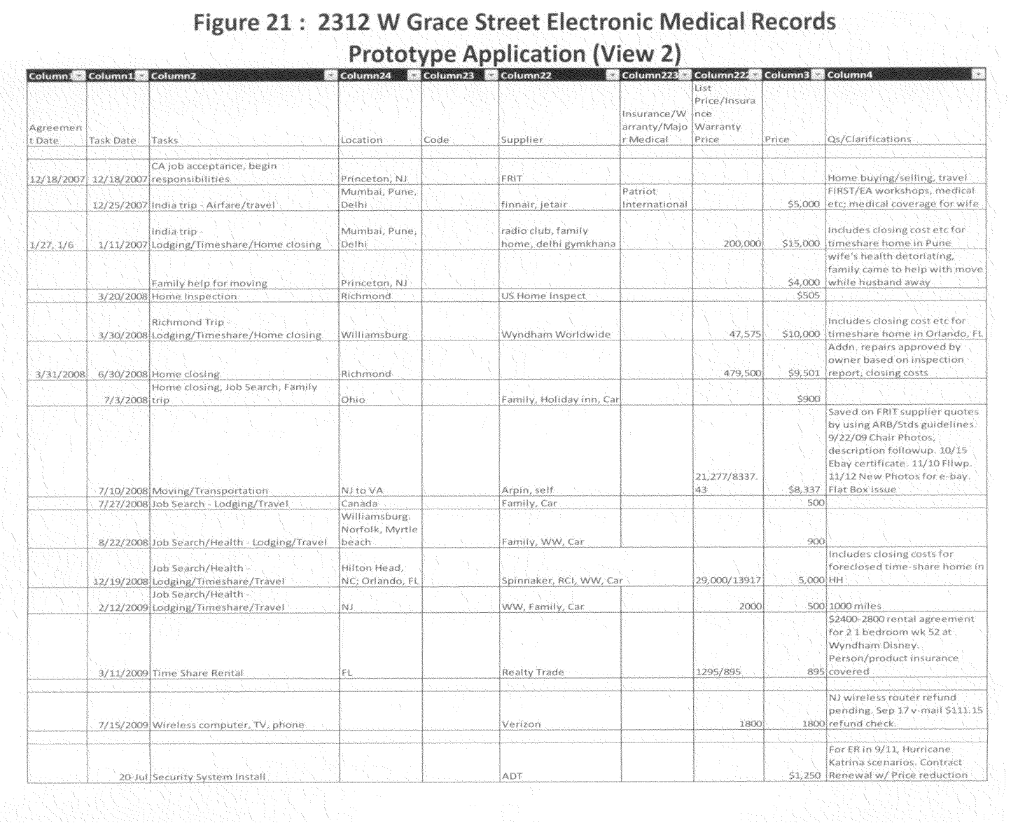

FIGS. 20 and 21 is a prototype application that shows the electronic medical records of a home and people, plants and pets living in the home. It is built on best practices from Zachman Framework, Feng Shui etc (Feng Shui is a 2000 yr old home healthcare science that originated in India/China). It also meets the US Presidential mandate to have electronic medical records for all US Citizens by 2014, while ensuring we have sufficient talent and knowledge transfer mechanisms with the upcoming baby boomer wave. It can be used for a multi-enterprise ecosystem across business, government and academia.

Column 1 shows the date/time of the task, activity and event. Column 12 shows the location where it occurred. Column 2 shows the task, activity and event. Column 24 shows the codes assigned for this. Some codes currently do exist. Others like the ones shown for preventive blood tests (Jul. 2, 2008. Princeton, N.J.) or bronchitis (Msr. 27, 2008, Richmond, Va.) have codes assigned per FDA compliance requirements. Column 22 shows the supplier of the product for home, people, plants and pets. Column 222 shows the insurance, warranty, major medical discount providers. Column 223 shows the list price and discounted price. Column 3 shows the final price. These prices can be used for scenario planning, simulation and a better understanding of which insurance/discount providers have the best products and solutions for your personal needs. Column 4 is for clarification questions and the workflows they initiate. Example see row 14 for broken chair under All tab. BPM software can be used for this. These workflows can also be used for exception handling and waivers. Clicking on any cell brings up the relevant pictures and records from one or multiple sources. As an example clicking on the task cell brings up the electronic medical record including e-receipts with e-signatures. The organizing (naming, taxonomy) of the EMR is based on UN standards that support multiple languages <date>_<person, plant, animal, car, home>_supplier. This is based upon what Feng Shui recommends also. This can be used to monitor the health of the person, home/timeshare surroundings when people move, relocate to find out if their health and productivity is increasing or decreasing as well as their cost of living. Census can make use of this data and government providing stimulus money or green grants can monitor how the home infrastructure renovations are affecting the person and their surroundings. Places with the best health and wellness index will attract people from all over the world for areas like medical tourism.

The underlying architecture of this prototype is discussed in the patent. Additional details (photos, workflows initiated when this User interface is clicked from an Apple iphone for eg are discussed in the claims section). $1M+ in billing & tracking of unreimbursed claims across local, state and federal are demonstrated in this prototype. It is based on personal experience. The conceptual architecture is similar to the Surround Architecture which was used by the author at his first company, MIT spin-off CTP that helped commercialize Unix and accelerated internet/e-commerce adoption. Author estimates that about $10M is needed to help commercialize these patents and prototype that could be also used for monitoring the stimulus package in US and green grants in other countries.

1. My conceptual blueprints are based on the work that was done to commercialize Unix at the MIT spin-off CTP using the Surround Architecture where I was a founding member and the award winning work done for the US Mint on a direct mandate from VP Al Gore—it was the 1^{st} time that a government agency won an award for customer satisfaction, second only to Mercedes Benz. The UDEF prototypes are based on the academic prototypes for remote blood monitoring done while I was at J&J. They will enable automated medical records for homes, cars, people, plants, pets etc by remotely monitoring air, water, food, blood, credit cards, checks etc and monitor the health & wellness index of local states, regions and countries. UN standards such as UDEF will enable us to do this across countries and even connect with the NASA International Space Station to address critical issues such as global warming, air/water quality and pandemics such as swine flue, regardless of whether the website is being accessed from a PC or from devices embedded in/on/around homes, cars or people. It will take Internet search to the next level in a multi-enterprise ecosystem. It will also enable the monitoring of the stimulus package in US and green grants in other countries for a fraction of what it costs us today while addressing issues such as the you tube video “Energy efficiency—The world in 2030” when the world population reaches 10B+. Air/water quality is predicted to become the single biggest issue by then. Tap water is already known to cause skin-rash & cancer in kids in Va.
My patents and academic prototypes are in alignment with our new President's priorities in energy, healthcare and education and would be able to provide healthcare coverage regardless of age or employment at a fraction of today's cost while create new business models for areas like medical tourism. It will ensure we have sufficient talent when 50% of the workforce in NA, Europe and Japan retire over the next 5-10 years, while meeting the government mandate to have electronic medical records for all US Citizens by 2014. It will also create growth opportunities for IT organizations while creating an estimated bottom-line saving of $162B annually to corporate America alone.

2. The attached spreadsheet is the Richmond 2.0 patent prototype application for 2312 W Grace Street home office environment electronic medical records uses best practices from Feng Shui etc (Feng Shui is a 2000 yr old home healthcare science) using UDEF IT standards that United Nations has adopted and which supports multiple languages. This is part of the multi-generational program I had initiated for the National IT Roadmap as chief architect at the Federal Reserve Bank, which was founded nearly a 100 years ago to ensure that the great depression and unemployment rates from that era did not happen again. My patents will generate significant cost savings for all companies through billing & tracking of unreimbursed claims, while creating growth opportunities for administrative areas in HR, Finance, Legal & IT by creating the equivalent of GM*OnStar for a healthy economy. Diversity initiatives can be used for achieving these goals.
Whenever quality and governance suffers (Cuban missile crises, globalization of mfg in '70s, September 11, global warming and the recent financial & healthcare crises), it impacts America and the whole world. The $787B stimulus package might get even worse when 50% of the workforce retires in the next 5-10 years and productivity suffers when the younger generation has to take care of the older generation. Prevention is better than cure—whether it is for energy (going green) or healthcare (cancer etc) or education (reducing terrorism by providing the right education in emerging countries like India, China, Afghanistan, Iraq etc not facing a retirement crises). The Richmond 2.0 prototype application can be modeled globally to create an environment that will be sustainable by the next generation when the world population reaches 10B+. A healthy person creates a healthy family/organization which creates a healthy economy.

3. My patents and prototype application are based on personal experience and the work I had initiated while in NJ and after accepting the job of chief architect at the Federal Reserve Bank. Better mechanisms need to be in place for governance in a real-time organization, including those for exception handling and waiver process. They need to ensure that entire organizations/industries/cities do not disappear due to lack of quality and compliance from a single individual or loss of knowledge due to the upcoming baby boomer wave. For example, I've recommended to Sonia Sotomeyer in USA and Sonia Gandhi in India that fact-finding interviews that take place at NJ/VEC EUC for granting unemployment insurance should be bi-directional not just uni-directional when people relocate across states/countries.
My prototype application shows the electronic signatures, e-receipts, workflows, medical records, financial transactions, wireless remote monitoring which are critical components of bi-directional governance in a real-time organization. They can be used for credit rating, rewards and compliance management, financial aid, tax purposes and scenario planning. It shows the relocation expenses and workflows that are triggered at the local, state and federal level. It can be used for measuring health and wellness, cost of living and productivity across local regions, states and countries. It will ensure that the same level of quality of life and insurance is available in a home/time-share/travel environment as in a work/mfg environment since so many people work from home or while travelling. Countries can use it for measuring ROI from the economic stimulus package in USA or green grants in other countries.
This is part of the multi-generational program I had initiated at the Federal Reserve Bank. I had accepted the position of chief architect, because my son wanted to be President of USA when he grows up and I have a passion, fashion and commitment for creating a greener, healthier, safer environment for the next generation. My ongoing work to create a Richmond 2.0 with FIRST/NASA, Open Group alliance using PTA, YMCA, scouts, alumni TIE networks to help reduce the cost of living, while attracting intellectual and financial capital from all over the world also involves Pune/Mumbai in India where Richmond residents were affected in the terrorist incident over Thanksgiving, 2008. The prototype functionality includes billing & tracking of unreimbursed claims and medical history to help reduce the $250 per hour it currently costs the US economy to relocate a sr exec/enterprise architect, including education, healthcare and environmental costs to family. 4 million jobs are slated to be created because of the economic stimulus package. Others shouldn't go through what my family has been through. Diversity initiatives can be used to achieve these goals.
My work is based on Thomas Jefferson's ethical principles and civil rights that US veterans have fought so hard to protect. My patents and prototype using UDEF standards that United Nations has adopted help explain a real-time regulatory architecture that can be used to integrate central banks in various countries (eg Federal Reserve in USA) and even connect with NASA Endeavour & International Space Station to address critical issues such as global warming, air/water quality and pandemics such as swine flue, regardless of whether the website is being accessed from a PC or from devices embedded in/on/around homes, cars or people. It will take Internet search to the next level in a multi-enterprise ecosystem. It will also enable the monitoring of the stimulus package in US and green grants in other countries for a fraction of what it costs us today. It is creating the equivalent of GM*OnStar for a healthy economy. A healthy person creates a healthy family/organization which creates a healthy economy.
